(19) United States
(12) Patent Application Publication
(10) Pub. No.: US 2026/0086444 A1
(43) Pub. Date: Mar. 26, 2026

(54) LIGHT SOURCE DEVICE AND PROJECTOR

(71) Applicant: SEIKO EPSON CORPORATION, Tokyo (JP)

(72) Inventors: Itsuki KUMAGAI, SHIOJIRI-SHI (JP); Yuma IZAWA, MATSUMOTO-SHI (JP); Takehiko HAGIHARA, AZUMINO-SHI (JP)

(21) Appl. No.: 19/336,833

(22) Filed: Sep. 23, 2025

(30) Foreign Application Priority Data
Sep. 25, 2024 (JP) 2024-166629

(51) Int. Cl. G03B 21/16; G03B 21/20; G03B 33/08; H04N 9/31

(52) U.S. Cl. CPC G03B 21/16; G03B 21/204; G03B 33/08; H04N 9/3144

(57) ABSTRACT

A light source device includes a light source for emitting light, a heat dissipation member for dissipating heat of the light source, a wavelength conversion device for converting a wavelength of the light emitted from the light source, a housing chassis having a housing space in which the light source and the wavelength conversion device are housed, and a heat transfer member that is provided to the housing chassis to constitute a part of an outer surface of the housing chassis, and is thermally coupled to the wavelength conversion device, wherein the heat dissipation member includes a substrate to which the heat of the light source is transferred, and a plurality of fins arranged at the substrate, and the substrate has a circulation port that penetrates the substrate to allow a part of an air current flowing through the heat dissipation member to flow through the heat transfer member.

The present application is based on, and claims priority from JP Application Serial Number 2024-166629, filed Sep. 25, 2024, the disclosure of which is hereby incorporated by reference herein in its entirety.

### BACKGROUND

1. Technical Field The present disclosure relates to a light source device and a projector.

### 2. Related Art

In the related art, a light source device including a light source and a phosphor is known (see, e.g., JP-A-2022-024355 and JP-A-2016-051073).

The light source device described in JP-A-2022-024355 includes a solid-state light source, a light source heatsink, a phosphor portion, a motor, a phosphor heatsink, a first intake fan, a first exhaust fan, and a second intake fan.

The solid-state light source includes a first light source and a second light source, and the light source heatsink is disposed on an opposite surface to a light emitting surface in each of the light sources. The first intake fan is disposed upstream in a flow direction of first cooling air, and the first exhaust fan is disposed downstream, with respect to the light source heatsink.

The phosphor portion includes a wheel, a phosphor applied to the wheel in an arc shape, and a light transmissive member to which the phosphor is not applied in the wheel, and is rotated by the motor. The phosphor portion is fixed to a lid member of an optical system box that houses an optical system, and is covered with a phosphor case. A phosphor heatsink is disposed at both sides across the phosphor case, and the second intake fan is disposed upstream in a flow direction of second cooling air with respect to the phosphor heatsink.

A light source device described in JP-A-2016-051073 includes a light source unit, a condenser lens, a phosphor wheel, a drive motor, and a cooling device. Blue light emitted from the light source unit is condensed by the condenser lens and is incident on the phosphor wheel rotated by the drive motor. A phosphor region containing a green phosphor, a phosphor region containing a red phosphor, and a blue transmissive region are concentrically formed on an exit-side surface of the phosphor wheel, and green light, red light, and blue light are emitted from the phosphor wheel in a time-division manner.

The cooling device includes a heat pipe coupled to a base plate of the light source unit, a plurality of fins for cooling the heat pipe, and a fan, and a part of the phosphor wheel is disposed between the fins. The air as a cooling medium at a side where the phosphor wheel is disposed is sucked by the fan and flows between the fins. Accordingly, the phosphor wheel and the plurality of fins are cooled, and by extension, the phosphor wheel and the light source unit are cooled.

JP-A-2022-024355 and JP-A-2016-051073 are examples of the related art.

However, in the light source device described in JP-A-2022-024355, since the solid-state light source and the phosphor portion are cooled by cooling mechanisms disposed individually, it is possible to effectively cool each of the solid-state light source and the phosphor portion, but there is a problem that the size of the light source device is likely to increase.

Therefore, as in the light source device described in JP-A-2016-051073, it is conceivable to dispose the phosphor wheel and the plurality of fins on the flow path of the cooling medium sucked by the fan.

However, in such a configuration, the cooling medium that has cooled the phosphor wheel located upstream in the flow path of the cooling medium sucked by the fan flows through some of the plurality of fins. Therefore, there is a problem that the cooling efficiency of the plurality of fins, that is, the cooling efficiency of the light source unit is likely to decrease. Meanwhile, when it is attempted to ensure the cooling efficiency of each of the light source unit and the phosphor wheel, it is required to increase the sizes of the plurality of fins and the fan, and thus there is a problem that the size of the light source device is likely to increase.

Accordingly, there has been a demand for a configuration of a light source device capable of achieving the reduction in size of the whole of the device while ensuring the cooling efficiency of each of the light source and the phosphor.

### SUMMARY

A light source device according to a first aspect of the present disclosure includes a light source configured to emit light, a heat dissipation member configured to dissipate heat of the light source, a wavelength conversion device configured to convert a wavelength of the light emitted from the light source, a housing chassis having a housing space in which the light source and the wavelength conversion device are housed, and a heat transfer member that is provided to the housing chassis to constitute a part of an outer surface of the housing chassis, and is thermally coupled to the wavelength conversion device, wherein the heat dissipation member includes a substrate to which the heat of the light source is transferred, and a plurality of fins arranged at the substrate, and the substrate has a circulation port that penetrates the substrate to allow a part of an air current flowing through the heat dissipation member to flow through the heat transfer member.

A projector according to a second aspect of the present disclosure includes the light source device according to the first aspect described above, a light modulation device configured to modulate light emitted from the light source device, a projection optical device configured to project the light modulated by the light modulation device, and a fan configured to cause an air current to flow through the heat dissipation member.

### BRIEF DESCRIPTION OF THE DRAWINGS

FIG. 1 is a perspective view showing an appearance of a projector according to an embodiment.

FIG. 2 is a schematic diagram showing a configuration of an image projection device in an embodiment.

FIG. 3 is a schematic diagram showing a configuration of a light source device in an embodiment.

FIG. 4 is a perspective view showing a wavelength conversion device and a heat transfer member in an embodiment.

FIG. 5 is a perspective view showing a light source device in an embodiment.

FIG. 6 is a perspective view showing a light source device in an embodiment.

FIG. 7 is an exploded perspective view showing a light source device in an embodiment.

FIG. 8 is an exploded perspective view showing a light source device in an embodiment.

FIG. 9 is an exploded perspective view showing a heat dissipation member in an embodiment.

FIG. 10 is an exploded perspective view showing a heat dissipation member in an embodiment.

FIG. 11 is a perspective view showing an arrangement of a light source device and a fan in an embodiment.

FIG. 12 is a side view showing a light source device and a fan in an embodiment.

FIG. 13 is a view showing a positional relationship between a circulation port of a substrate and a fan in an embodiment.

FIG. 14 is a view showing a positional relationship between a circulation port of a substrate, and a heat pipe and fins in an embodiment.

FIG. 15 is a view showing an air current delivered from a fan in an embodiment.

FIG. 16 is a view showing an air current delivered from a fan in an embodiment.

### DESCRIPTION OF EMBODIMENTS

An embodiment of the present disclosure will hereinafter be described based on the drawings.

### Schematic Configuration of Projector

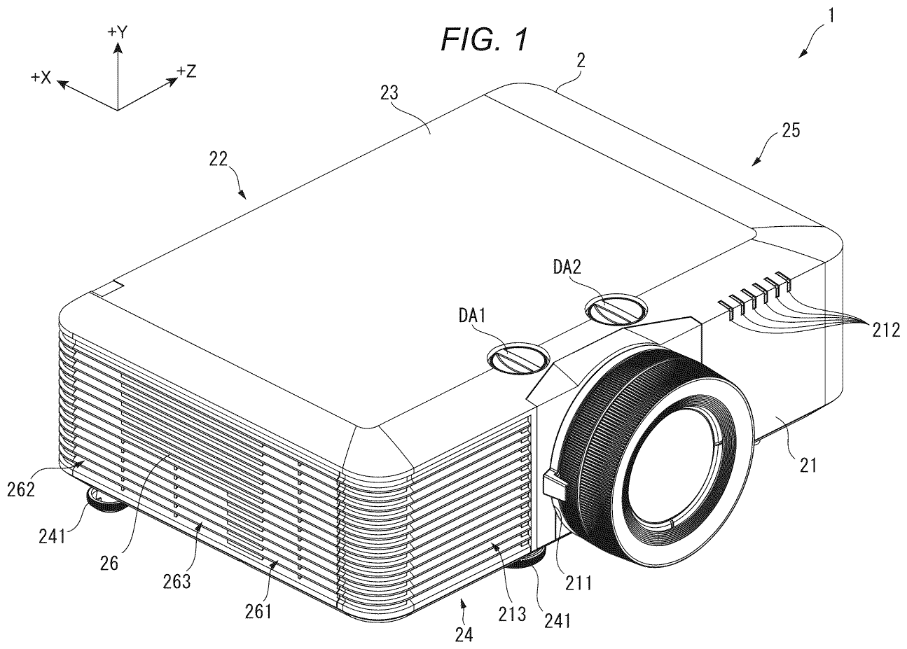

FIG. 1 is a perspective view showing an appearance of a projector 1 according to the present embodiment.

The projector 1 according to the present embodiment is a display apparatus that modulates light emitted from a light source device, forms image light according to an image signal, and projects the image light thus formed onto a projection surface. As shown in FIG. 1, the projector 1 includes an exterior chassis 2.

### Configuration of Exterior Chassis

The exterior chassis 2 has a front surface portion 21, a back surface portion 22, a top surface portion 23, a bottom surface portion 24, a right side surface portion 25, and a left side surface portion 26, and is formed in a substantially rectangular parallelepiped shape.

The front surface portion 21 has a projection port 211, a plurality of indicators 212, and a first introduction port 213. The projection port 211 exposes a part of a projection optical device 36 of an image projection device 3 described later. The plurality of indicators 212 are disposed at the right side surface portion 25 side with respect to the projection port 211, and indicates the state of the projector 1. The first introduction port 213 is disposed at the left side surface portion 26 side with respect to the projection port 211, and introduces air located outside the exterior chassis 2 into the exterior chassis 2 as a cooling gas. Although details will be described later, a fan 8 described later is disposed inside the exterior chassis 2 corresponding to the first introduction port 213, and the cooling gas sucked by the fan 8 via the first introduction port 213 is delivered to the light source device 4 as an air current.

Two dials DA1, DA2 for operating a lens shift mechanism described later are exposed on the top surface portion 23.

The bottom surface portion 24 is provided with a plurality of leg portions 241 in contact with an installation surface on which the projector 1 is installed.

Although not illustrated in detail, the right side surface portion 25 has a second introduction port for introducing air located outside the exterior chassis 2 into the exterior chassis 2 as the cooling gas.

The left side surface portion 26 has three discharge ports 261, 262, 263.

The discharge port 261 is disposed at a position at the front surface portion 21 side in the left side surface portion 26. The discharge port 261 discharges the air current having passed through a heatsink 74 provided to the light source device 4 described later.

The discharge port 262 is disposed at a position at the back surface portion 22 side in the left side surface portion 26. The discharge port 262 discharges the air current that has been introduced into the exterior chassis 2 from the second introduction port of the right side surface portion 25 and has cooled the cooling target in the exterior chassis 2.

The discharge port 263 is disposed at a position at the bottom surface portion 24 side between the discharge ports 261, 262 in the left side surface portion 26. The discharge port 263 discharges the air current having passed through a heat transfer member 65 provided to the light source device 4 described later.

A flow of the air that is delivered from the fan 8 to cool the heatsink 74 and the heat transfer member 65 will be described later in detail.

### Configuration of Image Projection Device

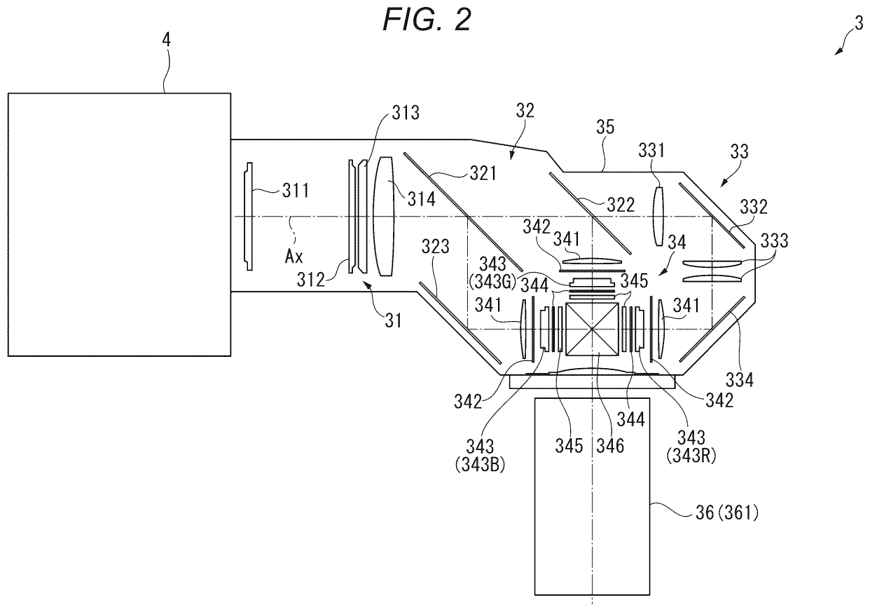

FIG. 2 is a schematic diagram illustrating a configuration of the image projection device 3.

The projector 1 includes the image projection device 3 housed inside the exterior chassis 2.

The image projection device 3 projects image light according to the image signal. As illustrated in FIG. 2, the image projection device 3 includes the light source device 4, a homogenization device 31, a color separation device 32, a relay device 33, an image forming device 34, an optical component chassis 35, a projection optical device 36, and a lens shift mechanism (not illustrated).

The light source device 4 emits light. A configuration of the light source device 4 will be described later in detail.

The homogenization device 31 homogenizes an illuminance distribution of the light emitted from the light source device 4. The light an illuminance distribution of which is homogenized illuminates a modulation region of a light modulation device 343 described later of the image forming device 34 via the color separation device 32 and the relay device 33. The homogenization device 31 includes two lens arrays 311, 312, a polarization conversion element 313, and a superimposing lens 314.

The color separation device 32 separates the light incident from the homogenization device 31 into colored light of red light, green light, and blue light. The color separation device 32 includes two dichroic mirrors 321, 322 and a reflecting mirror 323 that reflects the blue light separated by the dichroic mirror 321.

The relay device 33 is disposed in a light path of the red light longer than light paths of other colored light, and suppresses a loss of the red light. The relay device 33 includes an incident-side lens 331, a relay lens 333, and reflecting mirrors 332, 334. In the present embodiment, the relay device 33 is disposed on the light path of the red light. However, this is not a limitation, and for example, a configuration may be adopted in which the light path of the blue light is longer than the light paths of other colored light, for example, and the relay device 33 is disposed on the light path of the blue light.

The image forming device 34 forms the image light from the light emitted from the light source device 4. Specifically, the image forming device 34 modulates the incident colored light, that is, the red light, the green light, and the blue light, and combines the modulated colored light to form the image light. The image forming device 34 includes three field lenses 341, three incident-side polarization plates 342, three light modulation devices 343, three view angle compensation plates 344, three exit-side polarization plates 345, and one color combining element 346, which are disposed so as to correspond to the incident colored light.

The light modulation device 343 modulates the incident light in accordance with image information. The light modulation devices 343 include a light modulation device 343R for red light, a light modulation device 343G for green light, and a light modulation device 343B for blue light. In the present embodiment, the light modulation device 343 is formed of a transmissive liquid crystal panel, and a liquid crystal light valve is configured with the incident-side polarization plate 342, the light modulation device 343, and the exit-side polarization plate 345.

The color combining element 346 combines the colored light respectively modulated by the light modulation devices 343B, 343G, and 343R to form the image light. The color combining element 346 is formed of a cross dichroic prism in the present embodiment, but this is not a limitation, and it is possible to configure the color combining element 346 with, for example, a plurality of dichroic mirrors.

The optical component chassis 35 incorporates the devices 31 to 34 described above. Note that an illumination light axis Ax, which is a design optical axis, is set in the image projection device 3, and the optical component chassis 35 holds the devices 31-34 at predetermined positions on the illumination light axis Ax. The light source device 4 and the projection optical device 36 are disposed at predetermined positions on the illumination light axis Ax.

The projection optical device 36 is a projection lens that projects the image light formed by the image forming device 34 onto the projection surface in an enlarged manner. That is, the projection optical device 36 projects the light modulated by the light modulation devices 343B, 343G, and 343R. The projection optical device 36 is configured as a combination lens obtained by, for example, housing a plurality of lenses in a lens barrel 361 having a cylindrical shape.

The lens shift mechanism moves the lens barrel 361 in a direction orthogonal to a lens optical axis of the projection optical device 36. When one of the dials DA1, DA2 is operated, the lens shift mechanism moves the lens barrel 361 along a direction connecting the top surface portion 23 and the bottom surface portion 24. When the other of the dials DA1, DA2 is operated, the lens shift mechanism moves the lens barrel 361 along a direction connecting the right side surface portion 25 and the left side surface portion 26. Thus, the projection position of the image light on the projection surface by the projection optical device 36 is moved.

### Configuration of Light Source Device

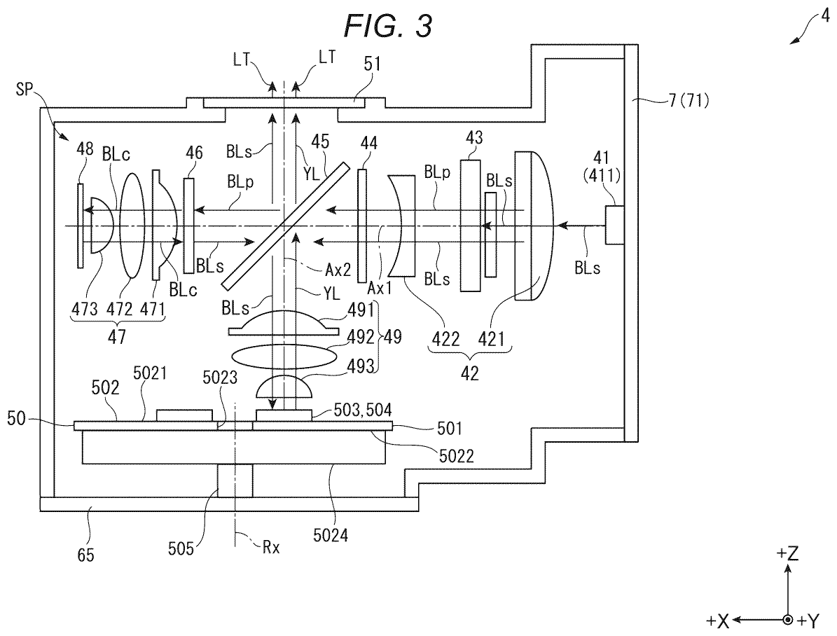

FIG. 3 is a schematic diagram illustrating a configuration of the light source device 4.

The light source device 4 emits illumination light that illuminates the light modulation devices 343 of the image forming device 34 to the homogenization device 31. As shown in FIG. 3, the light source device 4 includes a light source 41, an afocal optical element 42, a first retardation element 43, a diffuse transmission element 44, a light separating-combining element 45, a second retardation element 46, a first light collection element 47, a diffusion optical element 48, a second light collection element 49, a wavelength conversion device 50, and a third retardation element 51, and further includes a light source chassis 6 that houses these components.

Note that the light source chassis 6 will be described later in detail.

An optical axis Ax1 extending linearly and an optical axis Ax2 that is orthogonal to the optical axis Ax1 and extends linearly are set in the light source device 4. The optical axis Ax2 overlaps the illumination light axis Ax in the homogenization device 31.

The light source 41, the afocal optical element 42, the first retardation element 43, the diffuse transmission element 44, the light separating-combining element 45, the second retardation element 46, the first light collection element 47, and the diffusion optical element 48 are disposed on the optical axis Ax1.

The wavelength conversion device 50, the second light collection element 49, the light separating-combining element 45, and the third retardation element 51 are disposed on the optical axis Ax2.

In the following description, three directions perpendicular to each other are defined as a +X direction, a +Y direction, and a +Z direction. In the present embodiment, the +X direction is a direction in which the light source 41 emits light along the optical axis Ax1, and is also a direction from the front surface portion 21 toward the back surface portion 22. The +Z direction is a direction in which the light source device 4 emits the illumination light along the optical axis Ax2, and is also a direction in which the wavelength conversion device 50 emits light along the optical axis Ax2. The +Z direction is also a direction from the left side surface portion 26 toward the right side surface portion 25. The +Y direction is also a direction from the bottom surface portion 24 toward the top surface portion 23. Although not shown in the drawings, an opposite direction to the +X direction is defined as a −X direction, an opposite direction to the +Y direction is defined as a −Y direction, and an opposite direction to the +Z direction is defined as a −Z direction.

### Configuration of Light Source

The light source 41 includes at least one solid-state light emitting element 411, and the at least one solid-state light emitting element 411 emits, in the +X direction, light to be incident on the diffusion optical element 48 and the wavelength conversion device 50. The solid-state light emitting element 411 emits the blue light as excitation light. For example, the solid-state light emitting element 411 is a laser diode (LD) that emits a laser beam having a peak wavelength of 440 nm. Such a light source 41 is fixed to a substrate 71 of the heat dissipation member 7 described later.

The light emitted by the light source 41 is blue light BLs as s-polarized light with respect to the light separating-combining element 45. However, this is not a limitation, and the light emitted by the light source 41 may be blue light BLp as p-polarized light with respect to the light separating-combining element 45 or may be blue light in which s-polarized light and p-polarized light are mixed with each other. In the latter case, the first retardation element 43 can be omitted.

### Configuration of Afocal Optical Element

The afocal optical element 42 adjusts a light flux diameter of the blue light BLs incident thereon in the +X direction from the light source 41. The afocal optical element 42 includes a lens 421 that collects light incident thereon and a lens 422 that collimates a light flux collected by the lens 421. Note that the afocal optical element 42 may be eliminated.

### Configuration of First Retardation Element

The first retardation element 43 is disposed between the lens 421 and the lens 422. The first retardation element 43 converts a part of the blue light BLs incident thereon into the blue light BLp and emits light including the blue light BLs as the s-polarized light and the blue light BLp as the p-polarized light. The first retardation element 43 is rotated about a rotational axis along the optical axis Ax1 by a rotation device (not shown), and thus a ratio between an s-polarized light component and a p-polarized light component in the blue light emitted from the first retardation element 43 is adjusted in accordance with the rotation angle of the first retardation element 43. However, this is not a limitation, and a configuration in which the first retardation element 43 is not rotated may be adopted.

### Configuration of Diffuse Transmission Element

The diffuse transmission element 44 homogenizes an illuminance distribution of the blue light BLp, BLs incident thereon in the +X direction from the lens 422. The blue light BLs, BLp transmitted through the diffuse transmission element 44 is incident on the light separating-combining element 45. Examples of the diffuse transmission element 44 include a configuration having a hologram, a configuration in which a plurality of small lenses are arrayed in a plane orthogonal to an optical axis, and a configuration in which a surface through which light passes is a coarse surface.

Note that instead of the diffuse transmission element 44, a homogenizer optical element including a pair of multi-lenses may be adopted.

### Configuration of Light Separating-Combining Element

The light separating-combining element 45 has a function as a light splitting element that splits the incident light and a function as a light combining element that combines light incident thereon from two directions.

The light separating-combining element 45 is a polarization beam splitter and splits the incident light into the s-polarized light component and the p-polarized light component contained in the incident light. Specifically, the light separating-combining element 45 reflects the s-polarized light component and transmits the p-polarized light component. Further, the light separating-combining element 45 has a color separation characteristic of transmitting light no lower in wavelength than a predetermined wavelength regardless of whether the polarized light component is the s-polarized light component or the p-polarized light component. Therefore, out of the blue light BLp, BLs incident on the light separating-combining element 45 from the diffuse transmission element 44, the blue light BLp as the p-polarized light is transmitted through the light separating-combining element 45 in the +X direction and is incident on the second retardation element 46. Meanwhile, the blue light BLs as the s-polarized light is reflected by the light separating-combining element 45 toward the −Z direction and is incident on the second light collection element 49.

Note that the light separating-combining element 45 may be an element having a function as a half mirror that transmits a part of light incident from the light source 41 via the diffuse transmission element 44 and reflects the rest of the light and a function as a dichroic mirror that reflects the blue light incident from the diffusion optical element 48 and transmits fluorescence incident from the wavelength conversion device 50 and longer in wavelength than the blue light. In this case, the first retardation element 43 can be omitted.

### Configuration of Second Retardation Element

The second retardation element 46 is disposed at the +X direction side of the light separating-combining element 45. That is, the second retardation element 46 is disposed between the light separating-combining element 45 and the first light collection element 47. The second retardation element 46 converts the blue light BLp transmitted through the light separating-combining element 45 in the +X direction into blue light BLc as circularly polarized light. The blue light BLc transmitted through the second retardation element 46 in the +X direction is incident on the first light collection element 47.

### Configuration of First Light Collection Element

The first light collection element 47 converges, on the diffusion optical element 48, the blue light BLc transmitted through the light separating-combining element 45 in the +X direction and incident thereon from the second retardation element 46. Further, the first light collection element 47 collimates light incident thereon in the −X direction from the diffusion optical element 48 and then emits the result to the second retardation element 46. In the present embodiment, although the first light collection element 47 includes three lenses 471, 472, and 473, the number of lenses forming the first light collection element 47 does not matter.

### Configuration of Diffusion Optical Element

The diffusion optical element 48 diffuses, at substantially the same diffusion angle as a diffusion angle of the fluorescence YL emitted from the wavelength conversion device 50, the blue light BLc incident thereon. Specifically, the diffusion optical element 48 reflects, in the −X direction, and diffuses the blue light BLc incident in the +X direction from the first light collection element 47. The diffusion optical element 48 is a reflective element that causes Lambertian reflection of the blue light BLc incident thereon. Note that the diffusion optical element 48 may be rotated by a rotation device about a rotational axis parallel to the optical axis Ax2.

The blue light BLc diffused by the diffusion optical element 48 is transmitted through the first light collection element 47 in the −X direction and is then incident on the second retardation element 46. When the blue light BLc incident on the diffusion optical element 48 is reflected by the diffusion optical element 48, the blue light BLc is converted into circularly polarized light having a rotational direction opposite to the rotational direction of the blue light BLc. For this reason, the blue light BLc incident on the second retardation element 46 via the first light collection element 47 is converted into the blue light BLs as the s-polarized light by the second retardation element 46. Then, the blue light BLs is reflected in the +Z direction by the light separating-combining element 45 and is incident on the third retardation element 51.

### Configuration of Second Light Collection Element

The second light collection element 49 converges, on a phosphor layer 503 described later of a phosphor wheel 501 provided to the wavelength conversion device 50, the blue light BLs reflected in the −Z direction by the light separating-combining element 45. Further, the second light collection element 49 collimates the fluorescence YL incident in the +Z direction from the phosphor layer 503 and emits the fluorescence YL thus collimated to the light separating-combining element 45. In the present embodiment, although the second light collection element 49 is configured with three lenses 491, 492, and 493, the number of lenses forming the second light collection element 49 does not matter.

### Schematic Configuration of Wavelength Conversion Device

The wavelength conversion device 50 converts the wavelength of the blue light BLs incident in the −Z direction from the second light collection element 49 to emit the fluorescence YL in the +Z direction. That is, the wavelength conversion device 50 is a so-called reflective wavelength conversion device, and emits the fluorescence YL as unpolarized light having a wavelength longer than the wavelength of the blue light BLs in a direction opposite to the incident direction of the blue light BLs as the excitation light. The fluorescence YL is light including the green light and the red light, and is light further including the s-polarized light component and the p-polarized light component with respect to the light separating-combining element 45. Note that a configuration of the wavelength conversion device 50 will be described later in detail.

The fluorescence YL emitted from the wavelength conversion device 50 in the +Z direction is collimated by the second light collection element 49 and is then incident on the light separating-combining element 45. As explained above, since the light separating-combining element 45 has a characteristic of transmitting the fluorescence YL, the fluorescence YL incident on the light separating-combining element 45 in the +Z direction is transmitted through the light separating-combining element 45 and is incident on the third retardation element 51. That is, the light incident on the third retardation element 51 from the light separating-combining element 45 is white light in which the blue light BLs and the fluorescence YL are mixed with each other.

### Configuration of Third Retardation Element

The third retardation element 51 converts the white light including the blue light BLs and the fluorescence YL incident from the light separating-combining element 45 into white light in which s-polarized light and p-polarized light are mixed with each other. The white light converted in this way is emitted in the +Z direction as illumination light LT and is incident on the homogenization device 31 described above.

### Configuration of Wavelength Conversion Device

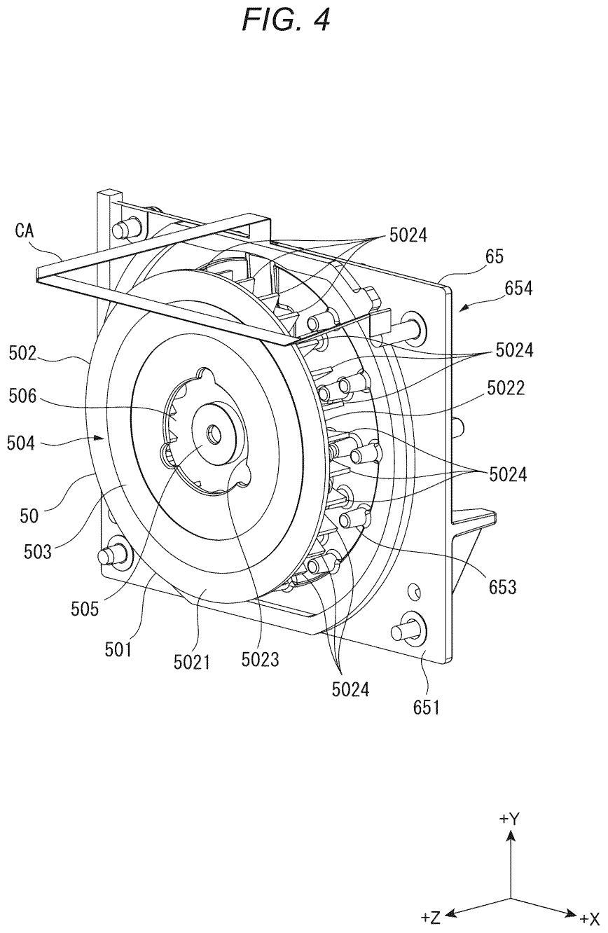

FIG. 4 is a perspective view showing the wavelength conversion device 50 and the heat transfer member 65.

The wavelength conversion device 50 converts the wavelength of the blue light BLs incident from the second light collection element 49 and emits the fluorescence YL. As shown in FIGS. 3 and 4, the wavelength conversion device 50 includes the phosphor wheel 501, a driver 505, and a hub 506.

Note that the driver 505 is a motor and is coupled to the phosphor wheel 501 via the hub 506. The driver 505 rotates the hub 506 to thereby rotate the phosphor wheel 501 about a rotational axis Rx along the optical axis Ax2. That is, hub 506 is a coupling member that couples the phosphor wheel 501 and driver 505 to each other. Note that a cable CA extends from the driver 505.

The phosphor wheel 501 includes a rotating plate 502, the phosphor layer 503, and a reflector 504.

The rotating plate 502 supports the phosphor layer 503 and the reflector 504. The rotating plate 502 is rotated about the rotational axis Rx by the driver 505. The rotating plate 502 has a first surface 5021, a second surface 5022, an opening 5023, and a plurality of fins 5024.

The first surface 5021 is a surface facing the +Z direction.

The second surface 5022 is a surface at an opposite side to the first surface 5021, and is a surface facing the −Z direction.

The opening 5023 is provided to a central portion of the rotating plate 502 and penetrates the rotating plate 502 along the rotational axis Rx. The opening 5023 is formed in a circular shape when viewed from the +Z direction which is the incident side of the blue light BLs.

The plurality of fins 5024 are disposed at an outer side of the opening 5023 on the second surface 5022. Although not illustrated in detail, each of the plurality of fins 5024 extends from a portion at the rotational axis Rx side toward the outer side of the rotating plate 502. In the present embodiment, each of the fins 5024 extends in a curved shape so as to be located at the opposite direction side to the rotational direction of the rotating plate 502 as proceeding from an end portion at the rotational axis Rx side toward the outer side of the rotating plate 502. However, this is not a limitation, and the extending direction of each of the fins 5024 can appropriately be changed.

The phosphor layer 503 is disposed in a ring shape around the rotational axis Rx at the outer side of the opening 5023 on the first surface 5021. The phosphor layer 503 contains a phosphor that converts the wavelength of the blue light BLs incident from the second light collection element 49. That is, the phosphor layer 503 is excited by the blue light BLs as the excitation light, and emits the fluorescence YL. Note that the phosphor layer 503 generates heat by the incidence of the blue light BLs. A part of the heat generated in the phosphor layer 503 is directly radiated from the phosphor layer 503, and the other heat is transferred to the rotating plate 502 via the reflector 504 and is radiated.

The reflector 504 is disposed between the phosphor layer 503 and the first surface 5021, and reflects, in the +Z direction, the light incident from the phosphor layer 503. Note that when the first surface 5021 can be used as a reflecting surface, the reflector 504 may be omitted.

When such a phosphor wheel 501 is rotated by the driver 505, a gas is sucked from a space at the first surface 5021 side, and an air current flowing from the opening 5023 toward the second surface 5022 side is generated. Such an air current flows between the plurality of fins 5024 disposed on the second surface 5022 toward the outer side of the rotating plate 502. Accordingly, the heat generated in the phosphor layer 503 and transferred to the plurality of fins 5024 is transferred to the air current, and the phosphor layer 503 is cooled. Note that the heat of the air current that has cooled the plurality of fins 5024 is received by the heat transfer member 65 coupled to an end portion in the −Z direction in the driver 505, and is radiated to the outside of the light source chassis 6.

### Configuration of Light Source Chassis

As shown in FIG. 3, the light source chassis 6 has a housing space SP that houses the light source 41, the afocal optical element 42, the first retardation element 43, the diffuse transmission element 44, the light separating-combining element 45, the second retardation element 46, the first light collection element 47, the diffusion optical element 48, the second light collection element 49, the wavelength conversion device 50, and the third retardation element 51. The light source chassis 6 is a sealed chassis difficult for dust and the like to enter.

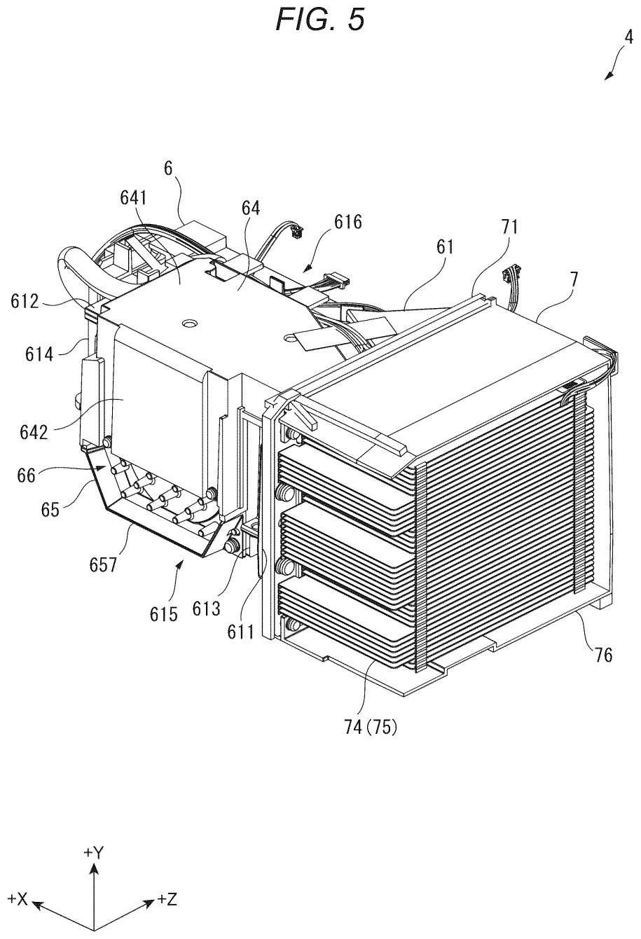

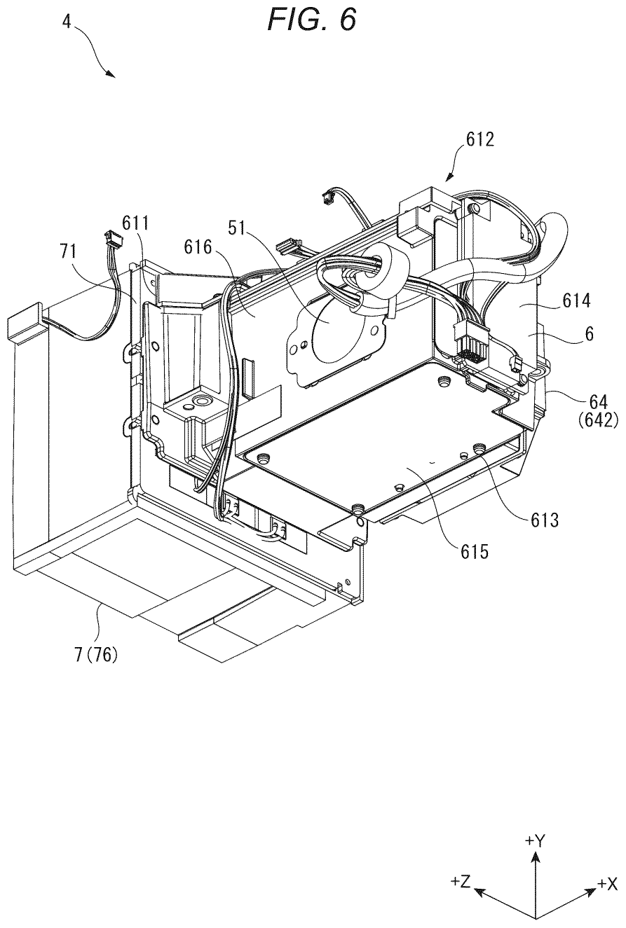

FIG. 5 is a perspective view illustrating the light source device 4 viewed from the −X direction, and FIG. 6 is a perspective view illustrating the light source device 4 viewed from the +X direction.

As illustrated in FIGS. 5 and 6, the light source chassis 6 includes a housing chassis 61, a duct 64, the heat transfer member 65, a discharge port 66, and a heat dissipation member 7.

### Configuration of Housing Chassis

The housing chassis 61 corresponds to a chassis in the present disclosure. The housing chassis 61 has a first surface 611, a second surface 612, a third surface 613, a fourth surface 614, a fifth surface 615, and a sixth surface 616.

The first surface 611 is an outer surface facing the −X direction and corresponds to a first outer surface. A substrate 71 of a heat dissipation member 7 described later is attached to the first surface 611. That is, at least a part of the first surface 611 is formed of the substrate 71.

The second surface 612 is a surface facing the +Y direction and corresponds to a second outer surface crossing the first surface 611. At least a part of the second surface 612 is formed of a lid member 63.

The third surface 613 is a surface facing the −Z direction and corresponds to a third outer surface crossing each of the first surface 611 and the second surface 612. At least a part of the third surface 613 is formed of the heat transfer member 65.

The fourth surface 614 is a surface facing the +X direction, and is a surface at an opposite side to the first surface 611.

The fifth surface 615 is a surface facing the −Y direction, and is a surface at an opposite side to the second surface 612.

The sixth surface 616 is a surface facing the +Z direction, and is a surface at an opposite side to the third surface 613. The sixth surface 616 is a surface from which the illumination light LT transmitted through the third retardation element 51 is emitted.

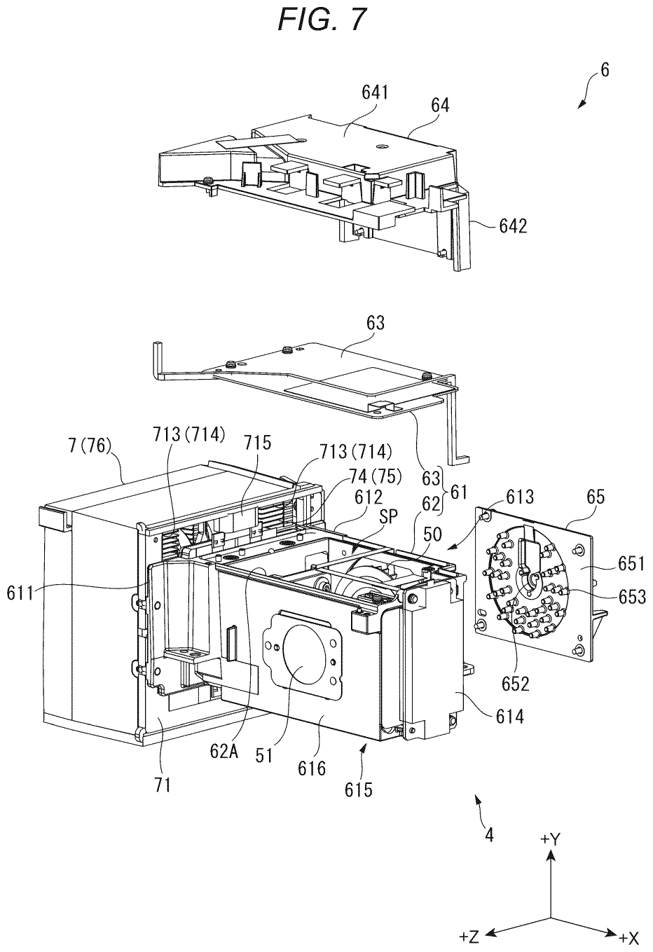

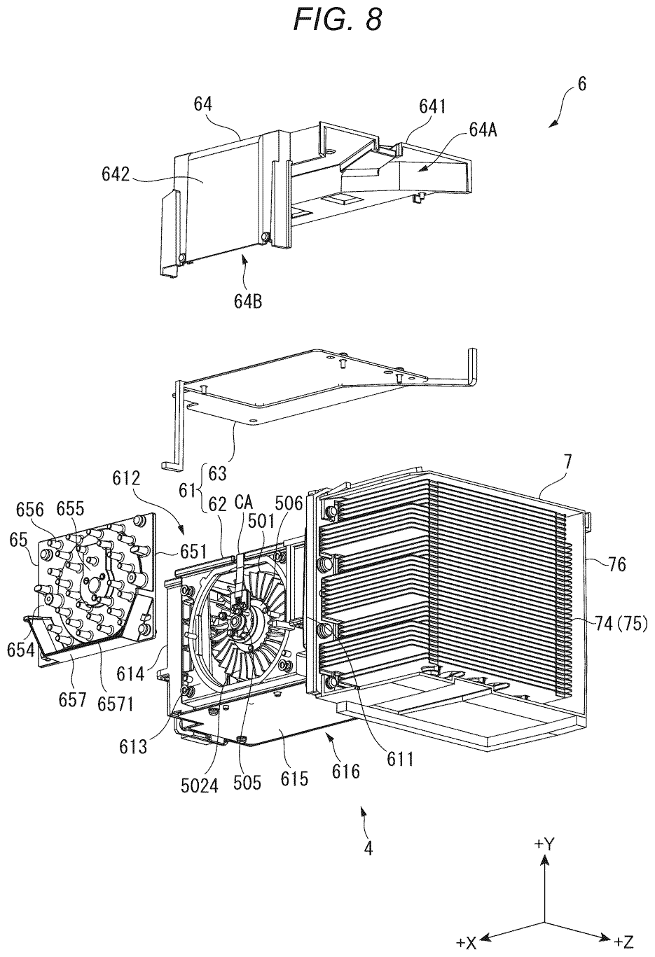

FIG. 7 is an exploded perspective view illustrating the light source device 4 viewed from the −X direction and the +Y direction, and FIG. 8 is an exploded perspective view illustrating the light source device 4 viewed from the +X direction and the −Y direction.

As shown in FIG. 7, the housing chassis 61 has the housing space SP described above. As shown in FIGS. 7 and 8, the housing chassis 61 includes a lower chassis 62 and the lid member 63, and is configured by combining the lower chassis 62 and the lid member 63 with each other.

The lower chassis 62 is a box-shaped chassis mainly forming a portion at the −Y direction side in the housing chassis 61. As shown in FIG. 7, the lower chassis 62 has a housing recess 62A that forms the housing space SP. The housing recess 62A is a recess recessed in the −Y direction from the surface at the +Y direction side in the lower chassis 62.

As illustrated in FIG. 7, the lid member 63 is a metal member attached to the lower chassis 62 so as to cover the housing recess 62A at the +Y direction side.

Here, the temperature of the gas in the housing space SP rises due to the heat generated by each of the light source 41 and the wavelength conversion device 50 disposed in the housing space SP. That is, the temperature of the gas in the housing space SP rises when the light source device 4 is turned on.

In contrast, the lid member 63 is in contact with the gas located in the housing space SP, and can lower the temperature in the housing space SP by receiving the heat from the gas in the housing space SP and radiating the heat to the outside of the housing chassis 61.

Note that an air current having passed through a circulation port 713 of the substrate 71 described later flows to the lid member 63, and the lid member 63 transfers the heat received from the gas in the housing space SP to the air current.

### Configuration of Heat Dissipating Member

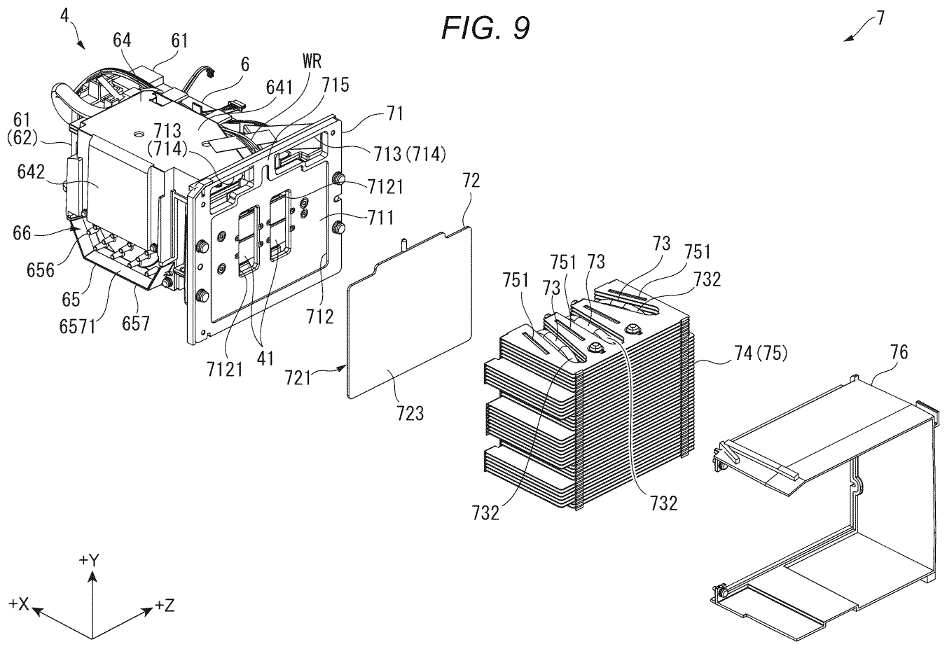

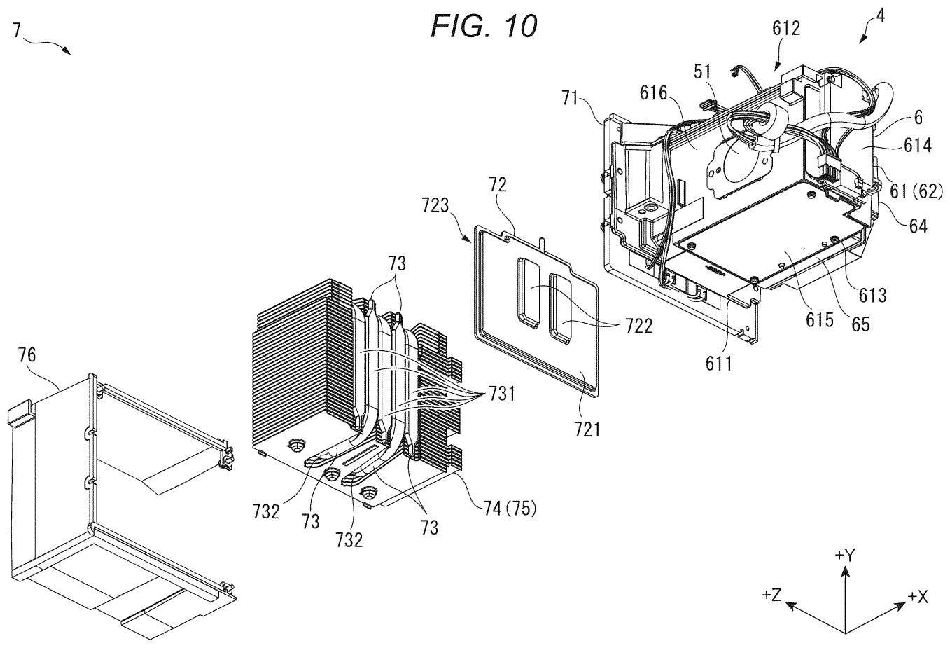

FIG. 9 is an exploded perspective view illustrating the heat dissipation member 7 viewed from the −X direction and the +Y direction, and FIG. 10 is an exploded perspective view illustrating the heat dissipation member 7 viewed from the +X direction and the −Y direction.

The heat dissipation member 7 dissipates the heat of the light source 41 transferred from the light source 41 to cool the light source 41. As illustrated in FIGS. 9 and 10, the heat dissipation member 7 includes the substrate 71, a heat pipe 73, a heatsink 74, and an air guide member 76.

### Configuration of Substrate

As illustrated in FIG. 9, the substrate 71 is a plate body formed in a substantially rectangular shape when viewed from the −X direction, and is attached to the first surface 611 of the housing chassis 61 with attachment members such as screws. That is, the substrate 71 forms at least a part of the first surface 611. Although not illustrated in detail, the solid-state light emitting element 411 of the light source 41 described above is fixed to a surface facing the +X direction in the substrate 71. That is, the substrate 71 supports the light source 41, and the heat of the light source 41 is transferred to the substrate 71.

The substrate 71 has, on a surface 711 facing the −X direction, an arrangement recess 712 in which a vapor chamber 72 is disposed. The arrangement recess 712 is a recess recessed in the +Z direction from the surface 711 in accordance with the shape of the vapor chamber 72 when viewed from the −X direction, and the vapor chamber 72 is attached to the arrangement recess 712 from the −X direction. That is, the light source device 4 has the vapor chamber 72 provided to the substrate 71.

Note that two through holes 7121 each having a substantially rectangular shape are provided to the bottom portion of the arrangement recess 712. Each of the two through holes 7121 penetrates the substrate 71 along the +X direction. Coupling portions 722 described later of the vapor chamber 72 disposed in the arrangement recess 712 are respectively inserted into the two through holes 7121, whereby the coupling portions 722 can come into contact with the light source 41.

The substrate 71 has the circulation port 713 penetrating the substrate 71 along the +X direction and a coupling portion 715.

The circulation port 713 is openings which allow a part of the air current passing through the heat dissipation member 7 to flow through the heat transfer member 65. The circulation port 713 is disposed at a position away from the center of the substrate 71. Specifically, the circulation port 713 is disposed at a position at the +Y direction side of the arrangement recess 712. In other words, the circulation port 713 is disposed at a position in the vicinity of an end portion in the +Y direction in the substrate 71. Although described later in detail, the circulation port 713 is disposed at a position corresponding to a circumferential edge of the fan 8 that makes the air current flow through the heat dissipation member 7 along the +X direction. In other words, the circulation port 713 is disposed at a position where the air current at the circumferential edge side out of the air current flowing from the fan 8 to the heat dissipation member 7 flows.

Such a circulation port 713 is configured with a plurality of openings 714 provided to the substrate 71 at a distance from each other. Specifically, the plurality of openings 714 are disposed side by side in the +Z direction at positions in the vicinity of the end portion in the +Y direction in the substrate 71. In the present embodiment, two openings 714 are provided, but the number of openings 714 constituting the circulation port 713 can appropriately be changed.

The coupling portion 715 is disposed between the plurality of openings 714 and couples inner edges of the respective openings 714. In the present embodiment, the coupling portion 715 is a portion that couples, in the +Z direction in which the plurality of openings 714 are arranged, the inner edge at the −Z direction side of the opening 714 located at the +Z direction side and the inner edge at the +Z direction side of the opening 714 located at the −Z direction side.

Cables WR extending from the light source 41 are disposed on a surface facing the +X direction in the coupling portion 715.

### Configuration of Vapor Chamber

The vapor chamber 72 is disposed in the arrangement recess 712 of the substrate 71 to form the substrate 71, and diffuses the heat received from the light source 41. The vapor chamber 72 has a heat receiving portion 721 and the coupling portions 722 illustrated in FIG. 10, and in addition, has a heat releasing portion 723 illustrated in FIG. 9.

The heat receiving portion 721 illustrated in FIG. 10 is a portion facing the +X direction in the vapor chamber 72 and faces the light source 41.

The coupling portions 722 are metal members made of copper or the like provided to the heat receiving portion 721. The coupling portions 722 are coupled to the light source 41 in a heat-transferable manner when the vapor chamber 72 is disposed in the arrangement recess 712. Therefore, a part of the heat generated by the light source 41 is transferred to the heat receiving portion 721 via the coupling portions 722, and evaporates a medium in a liquid phase located in the vapor chamber 72 on an inner surface of the heat receiving portion 721 to change the medium in the liquid phase into the medium in a gas phase.

The heat releasing portion 723 illustrated in FIG. 9 releases the heat of the medium in the gas phase changed by the heat receiving portion 721 to the outside of the vapor chamber 72 to condense the medium in the gas phase into the medium in the liquid phase. The medium in the liquid phase thus condensed moves in a sealed space in the vapor chamber 72 toward an inner surface of the heat receiving portion 721 with capillary force.

Note that heat receiving portions 731 of heat pipes 73 are coupled to the heat releasing portion 723, and the heat released from the heat releasing portion 723 is transferred to the heat receiving portions 731.

### Configuration of Heat Pipes

As shown in FIGS. 9 and 10, the heat pipes 73 are heat transport members that are coupled to the vapor chamber 72 and the heatsink 74 in a heat-transferable manner and transport the heat released from the vapor chamber 72 to the heatsink 74. The heat pipes 73 include the heat receiving portions 731 illustrated in FIG. 10, and in addition, include heat releasing portions 732 illustrated in FIGS. 9 and 10.

The heat receiving portions 731 are coupled to the heat releasing portion 723, and the heat releasing portions 732 are coupled to the heatsink 74. Thus, the heat pipes 73 transport the heat released from the heat releasing portion 723 of the vapor chamber 72 to the heatsink 74.

The heat dissipation member 7 includes the plurality of heat pipes 73, and in the present embodiment, the heat dissipation member 7 includes five heat pipes 73 arranged in the +Z direction. Each of the heat pipes 73 is bent in a substantially U-shape.

Out of the five heat pipes 73, three odd-numbered heat pipes 73 from the +Z direction side extend in the +Y direction from the heat receiving portions 731 and are then bent in a substantially U-shape, and the heat releasing portions 732 are coupled to the heatsink 74. Out of the five heat pipes 73, two even-numbered heat pipes 73 from the +Z direction side extend in the −Y direction from the heat receiving portions 731 and are then bent in a substantially U-shape, and the heat releasing portions 732 are coupled to the heatsink 74.

### Configuration of Heatsink

The heatsink 74 releases the heat transported by the heat pipes 73. Specifically, the heatsink 74 releases the transported heat to the air current delivered from the fan 8 described later. As illustrated in FIGS. 9 and 10, the heatsink 74 includes a plurality of plate-shaped fins 75 arranged along the X-Z plane, and is configured with the plurality of fins 75 arranged in the +Y direction and fixed to each other. That is, the heat dissipation member 7 includes the plurality of fins 75.

As illustrated in FIG. 9, each of the fins 75 includes a plurality of ribs 751 as protruding portions protruding in the −Y direction. The ribs 751 increase the surface area of the fins 75 to thereby enhance the heat dissipation of the fins 75. In addition, since the ribs 751 extend along the heat pipes 73 between the heat pipes 73, the air current delivered from the fan 8 is made easy to flow between the heat pipes 73.

### Configuration of Air Guide Member

As illustrated in FIGS. 9 and 10, the air guide member 76 is configured to have a substantially U-shape which opens toward the −Z direction when viewed from the ±X directions, and is disposed to surround the heatsink 74 in the +Y direction, the −Y direction, and the +Z direction. The air guide member 76 has a function of guiding, in the −Z direction, the air current delivered from the fan 8 described later toward the heatsink 74 and cooled the heatsink 74. Note that since the discharge port 261 is disposed at the −Z direction side with respect to the heatsink 74, the air current guided in the −Z direction by the air guide member 76 is discharged from the discharge port 261 to the outside of the exterior chassis 2.

### Configuration of Duct

As illustrated in FIGS. 7 and 8, the duct 64 is attached to the housing chassis 61 so as to cover a part of each of the second surface 612 and the third surface 613 of the housing chassis 61. The duct 64 causes the air current having passed through the circulation port 713 of the substrate 71 to flow along the second surface 612 and then to flow along the third surface 613.

The duct 64 includes a first duct portion 641 and a second duct portion 642.

The first duct portion 641 extends in the +X direction and covers, in the +Y direction, a portion configured with the lid member 63 in the second surface 612. A cross-section along the Y-Z plane defined by the +Y direction and the +Z direction in the first duct portion 641 is formed in a U-shape opening in the −Y direction. In the first duct portion 641, circumferential edges at the +X direction side and the +Z direction side are coupled to the second surface 612, and the circumferential edge at the −X direction side in the first duct portion 641 is coupled to the substrate 71.

A first duct 64A through which an air current can flow along the second surface 612 is configured inside the first duct portion 641. The air current having passed through the circulation port 713 flows in the first duct 64A and flows in the +X direction along the second surface 612.

The second duct portion 642 extends in the −Y direction from an end portion in the −Z direction in the first duct portion 641, and covers, in the −Z direction, a portion configured with the heat transfer member 65 in the third surface 613. A cross-section along the X-Z plane defined by the +X direction and the +Z direction in the second duct portion 642 is formed in a U-shape opening in the +Z direction. In the second duct portion 642, circumferential edges at the +X direction side and the −X direction side are coupled to a surface facing the −Z direction in the heat transfer member 65.

A second duct 64B through which an air current can flow along the heat transfer member 65 is configured inside the second duct portion 642. The air current having passed through the first duct 64A flows through the second duct 64B in the −Y direction along the heat transfer member 65.

Note that an end portion in the −Y direction in the second duct portion 642 is not coupled to the heat transfer member 65. Thus, although described later in detail, the light source chassis 6 is provided with the discharge port 66 for discharging the air current having flowed through the second duct 64B to the outside of the light source chassis 6.

### Configuration of Heat Transfer Member

As illustrated in FIGS. 7 and 8, the heat transfer member 65 is a plate-shaped member fixed to the housing chassis 61 to constitute a part of the third surface 613 of the housing chassis 61. That is, the heat transfer member 65 constitutes a part of an outer surface of the housing chassis 61. The heat transfer member 65 receives heat from the gas located in the housing space SP in addition to receiving heat from the driver 505 of the wavelength conversion device 50 described above. Further, the heat transfer member 65 releases the received heat to the outside of the housing chassis 61.

As illustrated in FIG. 7, the heat transfer member 65 includes a first surface 651, a coupling portion 652, and heat receiving pillars 653, and in addition, as illustrated in FIG. 8, the heat transfer member 65 includes a second surface 654, a protruding portion 655, heat releasing pillars 656, and a straightening portion 657.

As shown in FIG. 7, the first surface 651 is a surface facing the +Z direction in the heat transfer member 65. That is, the first surface 651 is a surface facing the wavelength conversion device 50 and attached to the lower chassis 62. The first surface 651 is a heat receiving surface that makes contact with the housing space SP to receive heat from the gas located in the housing space SP.

The coupling portion 652 is disposed at substantially the center of the first surface 651. An end portion in the −Z direction in the driver 505 is coupled to the coupling portion 652. Therefore, the heat generated by the driver 505 is received by the heat transfer member 65.

The heat receiving pillars 653 are a plurality of columnar portions erected in a region facing the second surface 5022 of the phosphor wheel 501 in the first surface 651. The plurality of heat receiving pillars 653 are arranged at substantially regular intervals along a plurality of concentric circles centered on the rotational axis Rx. The plurality of heat receiving pillars 653 are exposed in the housing space SP of the housing chassis 61 when the heat transfer member 65 is fixed to the housing chassis 61. Further, each of the plurality of heat receiving pillars 653 receives heat from the gas located in the housing space SP.

As shown in FIG. 8, the second surface 654 is a surface facing the −Z direction in the heat transfer member 65. In the second surface 654, a portion at the +Y direction side is covered, in the −Z direction, with the second duct portion 642 of the duct 64.

The protruding portion 655 is a portion protruding in the −Z direction corresponding to the coupling portion 652 in the second surface 654.

The heat releasing pillars 656 are a plurality of columnar portions erected on the periphery of the protruding portion 655 on the second surface 654. The plurality of heat releasing pillars 656 are arranged at substantially regular intervals along a plurality of concentric circles centered on the rotational axis Rx. Each of the plurality of heat releasing pillars 656 releases the heat of the driver 505 transferred to the coupling portion 652 and the heat of the gas located in the housing space SP received by the plurality of heat receiving pillars 653. Note that the heat releasing pillars 656 may be disposed at positions corresponding to the heat receiving pillars 653 on the second surface 654.

The straightening portion 657 is a standing wall standing in the −Z direction from a portion at the −Y direction side on the second surface 654. A central portion in the +X direction in the straightening portion 657 is located at the −Y direction side of an end portion at the +X direction side and an end portion at the −X direction side. Further, an end portion in the +X direction and the −Y direction in the second duct portion 642 of the duct 64 is coupled to the end portion in the +X direction of the straightening portion 657, and an end portion in the −X direction and the −Y direction in the second duct portion 642 is coupled to the end portion in the −X direction in the straightening portion 657. Therefore, the straightening portion 657 is combined with the duct 64 to form the discharge port 66 illustrated in FIGS. 5 and 9.

Note that a surface 6571 facing the −Z direction in the straightening portion 657 is an inclined surface protruding in the −Z direction toward the −Y direction. Therefore, the configuration of the heat transfer member 65 is a configuration in which the air current is easily discharged from the discharge port 66 along the straightening portion 657.

### Configuration of Fan

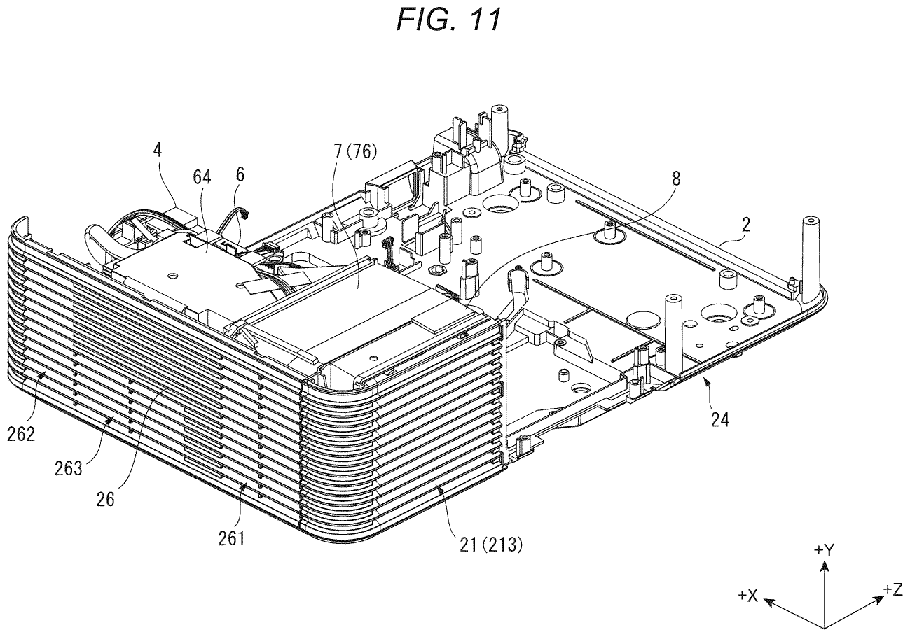

FIG. 11 is a perspective view illustrating an arrangement of the light source device 4 and the fan 8 in the exterior chassis 2.

In addition to the configuration described above, the projector 1 includes the fan 8 that causes an air current to flow through the light source device 4, as shown in FIG. 11.

The fan 8 is disposed in the exterior chassis 2 so as to correspond to the first introduction port 213 of the front surface portion 21. In other words, the fan 8 is disposed between the first introduction port 213 and the light source device 4 and at the −X direction side with respect to the light source device 4. The fan 8 delivers, toward the +X direction, the gas that has been located outside the exterior chassis 2 and has been introduced from the first introduction port 213 to generate an air current flowing through the heat dissipation member 7.

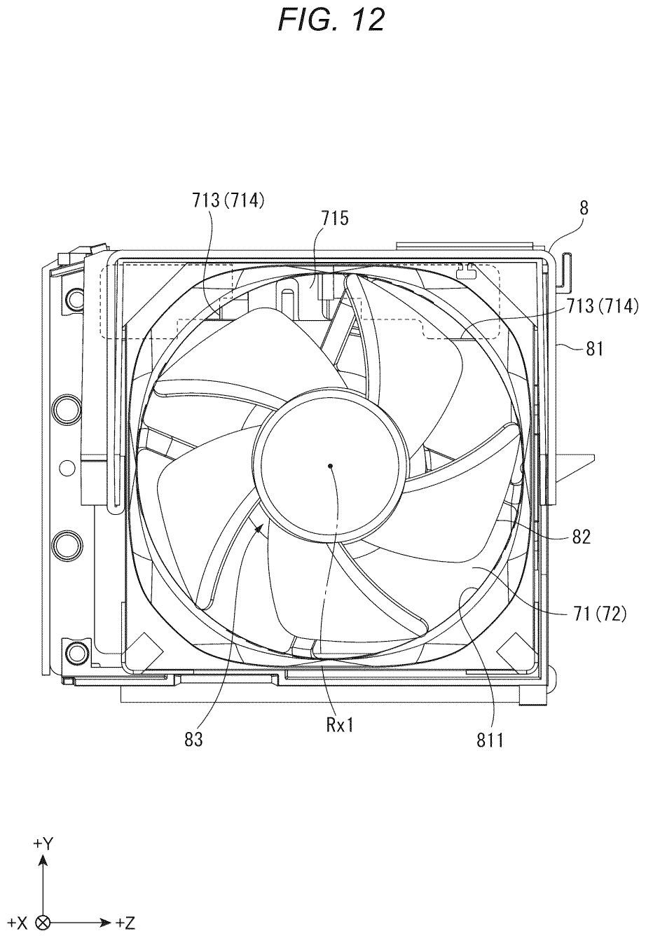

FIG. 12 is a side view of the light source device 4 and the fan 8 viewed from the −X direction. Note that in FIG. 12, illustration of the heatsink 74 constituting the heat dissipation member 7 is omitted.

In the present embodiment, the fan 8 is an axial fan including a fan case 81 having a substantially rectangular parallelepiped shape. As illustrated in FIG. 12, the fan 8 includes a blade member 82 that rotates about a rotational axis Rx1 along the +X direction and a motor 83 that rotates the blade member 82, and the blade member 82 and the motor 83 are disposed in the fan case 81.

Note that the fan case 81 has an opening 811 through which an air current passes. When viewed from the ±X directions, the inner edge of the opening 811 is formed in a circular shape along a rotation trajectory of an outer circumferential edge of the blade member 82.

### Positional Relationship Between Fan and Circulation Port

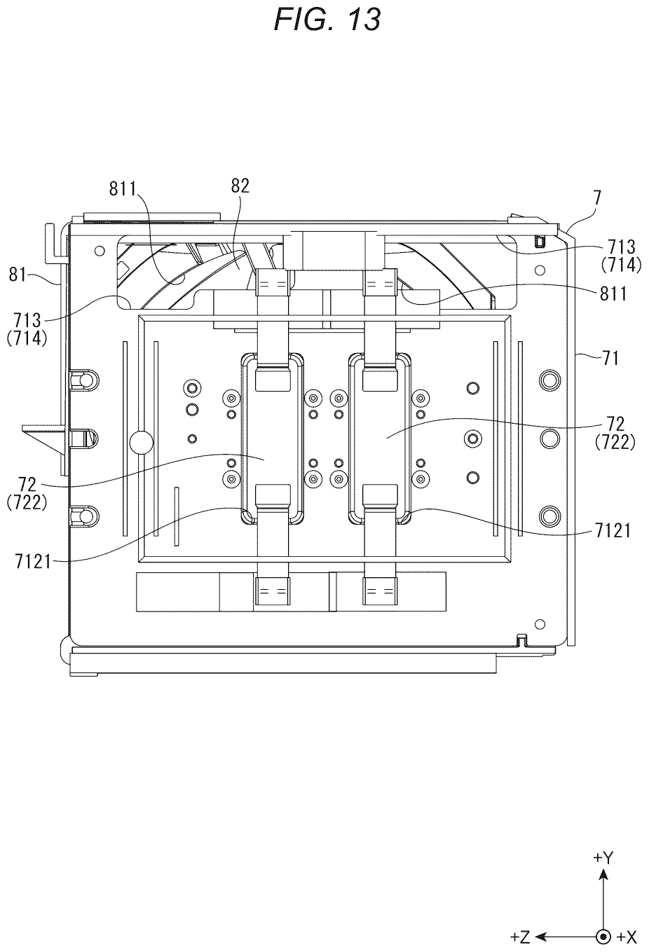

FIG. 13 is a diagram illustrating a positional relationship between the circulation port 713 of the substrate 71 and the fan 8 when viewed from the +X direction. Note that in FIG. 13, illustration of the heat pipes 73 and the heatsink 74 is omitted.

When the light source device 4 and the fan 8 are disposed in the exterior chassis 2, as illustrated in FIGS. 12 and 13, the circulation port 713 of the substrate 71 constituting the heat dissipation member 7 of the light source device 4 is disposed at a position away from the rotational axis of the fan 8 and close to the circumferential edge of the fan 8 when viewed from the ±X directions. That is, the circulation port 713 overlaps the fan 8 when the heat dissipation member 7 is viewed from the fan 8 side, and is located closer to the circumferential edge of the fan 8 than to the center of the fan 8. In the present embodiment, the circulation port 713 overlaps the circumferential edge of the opening 811 of the fan 8, and also overlaps the trajectory of the outer circumferential portion of the blade member 82 during the rotation when viewed from the ±X directions.

Therefore, when the fan 8 is driven, a part of the air current in the circumferential edge portion of the air current generated by the fan 8 flows through the circulation port 713. Meanwhile, the vapor chamber 72 overlaps the rotational axis of the blade member 82 when viewed from the −X direction. Most of the air current generated by the fan 8 flows through the fins 75 of the heatsink 74 coupled to the vapor chamber 72 via the heat pipes 73.

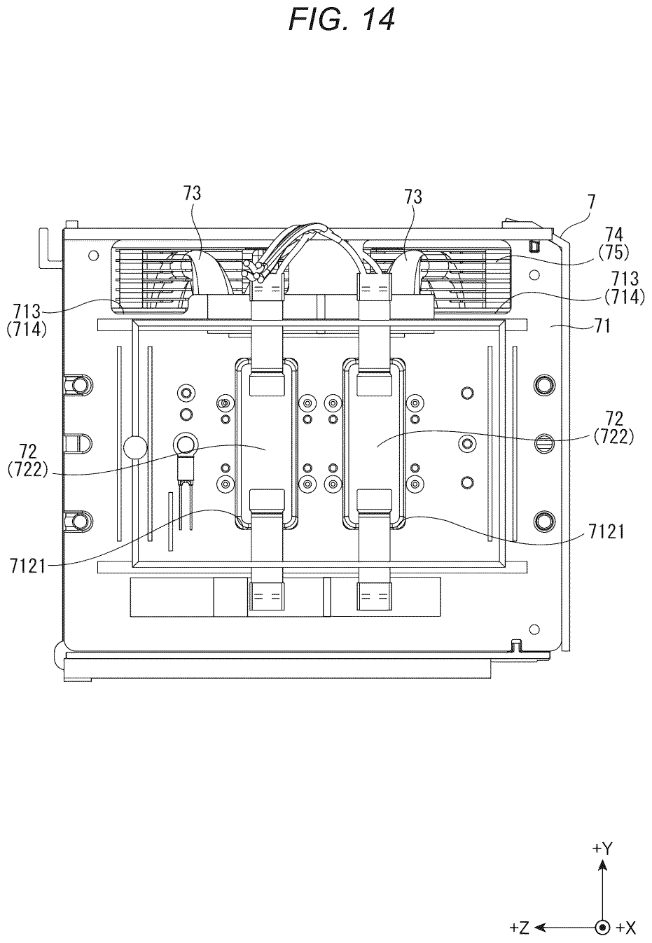

FIG. 14 is a diagram illustrating a positional relationship between the circulation port 713 of the substrate 71, and the heat pipes 73 and the fins 75 when viewed from the +X direction.

Note that as illustrated in FIG. 14, when the substrate 71 is viewed from the +X direction, each of the openings 714 of the circulation port 713 overlaps not only some of the plurality of fins 75 constituting the heatsink 74 but also a part of the heat pipes 73. The same applies to when the heat dissipation member 7 is viewed from the −X direction, which is the fan 8 side.

Therefore, the air current that is delivered from the fan 8 and passes through the circulation port 713 is an air current having flowed along not only the fins 75 but also the heat pipes 73.

However, this is not a limitation, and the circulation port 713 and the fins 75 are not required to overlap each other and the circulation port 713 and the heat pipes 73 are not required to overlap each other when viewed from the ±X directions.

### Air Current Delivered From Fan

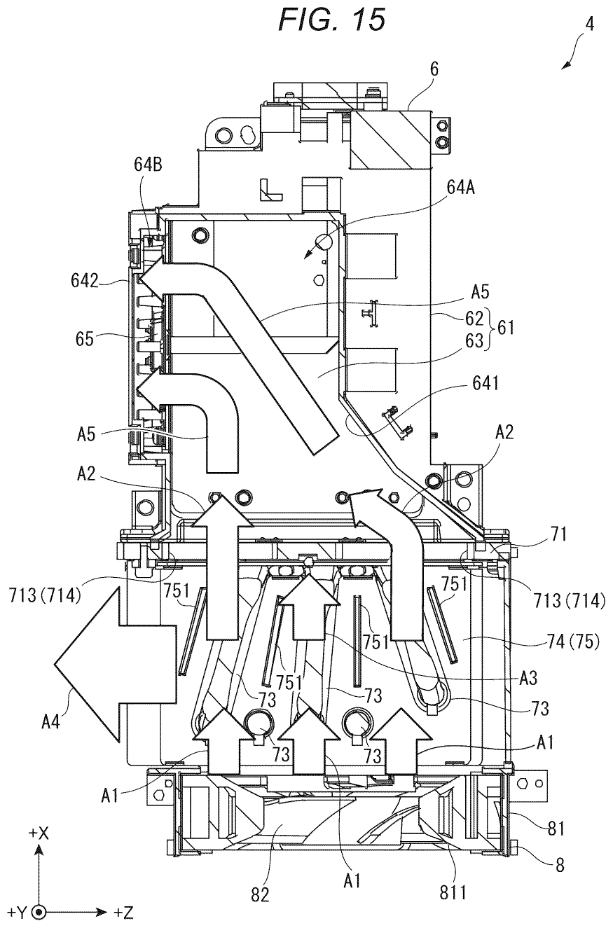

FIG. 15 is a diagram illustrating a cross-section of the light source device 4 and the fan 8 along the X-Z plane in the first duct portion 641, and in other words, FIG. 15 is a diagram illustrating an air current delivered from the fan 8.

When the fan 8 is driven, the gas located outside the exterior chassis 2 is sucked from the first introduction port 213 of the front surface portion 21, and the air current is delivered from the fan 8 to the heat dissipation member 7 as indicated by the arrows A1 in FIG. 15. The air current delivered from the fan 8 to the heat dissipation member 7 flows to the plurality of fins 75 constituting the heatsink 74 to which heat is transferred from the light source 41 via the vapor chamber 72 and the heat pipes 73.

Out of the air current having flowed through the plurality of fins 75, the air current flowing toward the circulation port 713 when viewed from the −X direction passes through some of the plurality of fins 75 in the +X direction and further passes through the openings 714 of the circulation port 713 in the +X direction as indicated by the arrows A2.

Out of the air current having flowed through the plurality of fins 75, the air current flowing toward a different portion of the substrate 71 from the circulation port 713 when viewed from the −X direction flows through the plurality of fins 75 in the +X direction as indicated by the arrow A3 to cool the plurality of fins 75. The air current that has cooled the plurality of fins 75 in this way is guided in the −Z direction by the air guide member 76, and is discharged to the outside of the exterior chassis 2 via the discharge port 261 as indicated by the arrow A4.

The air current having passed through each of the openings 714 in the +X direction flows through the first duct 64A in the +X direction. On this occasion, the air current flows along the lid member 63 constituting the first duct 64A. Accordingly, the lid member 63 to which the heat is transferred from the gas in the housing space SP is cooled, and thus the temperature in the housing space SP is lowered.

Then, the air current that has cooled the lid member 63 flows toward the second duct 64B as indicated by the arrows A5.

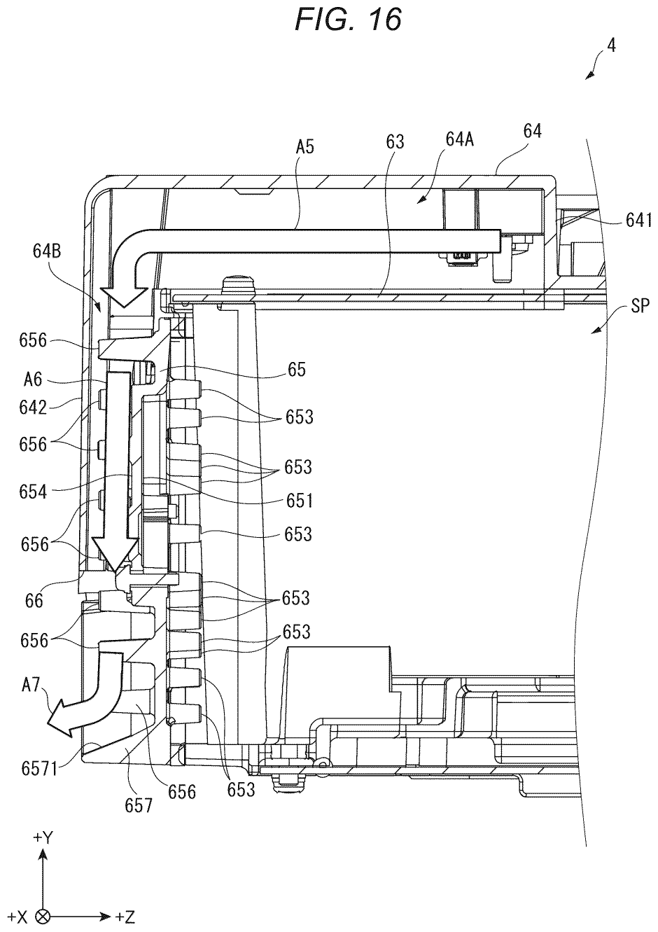

FIG. 16 is a diagram showing a cross-section of the light source device 4 along the Y −Z plane in the second duct portion 642. In other words, FIG. 16 is a diagram illustrating the air current delivered from the fan 8.

In FIG. 16, the air current that is indicated by the arrow A5 and flows into the second duct 64B flows through the second duct 64B in the −Y direction as indicated by the arrow A6. On this occasion, the air current flows along the second surface 654 and the heat releasing pillars 656 of the heat transfer member 65 to cool the heat transfer member 65. Since the heat of the driver 505 of the wavelength conversion device 50 and the heat of the gas located in the housing space SP are transferred to the heat transfer member 65, the temperature of each of the wavelength conversion device 50 and the housing space SP is lowered by cooling the heat transfer member 65.

The air current having flowed along the heat transfer member 65 is discharged to the outside of the light source device 4 through the discharge port 66 as indicated by the arrow A7. On this occasion, by the air current flowing along the surface 6571 of the straightening portion 657, it is possible to make it easy to discharge, from the discharge port 66, the air current having flowed through the second duct 64B.

Further, since the discharge port 66 faces the discharge port 263 provided to the left side surface portion 26 of the exterior chassis 2, the air current discharged from the discharge port 66 is discharged from the discharge port 263 to the outside of the exterior chassis 2.

### Advantages of Embodiment

The projector 1 according to the present embodiment described hereinabove provides the following advantages.

The projector 1 includes the light source device 4, the light modulation device 343 that modulates the light emitted from the light source device 4, the projection optical device 36 that projects the light modulated by the light modulation device 343, and the fan 8 that causes the air current to flow through the heat dissipation member 7 of the light source device 4.

The light source device 4 includes the light source 41 that emits light, the heat dissipation member 7 that dissipates heat of the light source 41, the wavelength conversion device 50 that converts the wavelength of the light emitted from the light source 41, the housing chassis 61 having the housing space SP that houses the light source 41 and the wavelength conversion device 50, and the heat transfer member 65 that is disposed in the housing chassis 61 to constitute a part of the outer surface of the housing chassis 61, and is thermally coupled to the wavelength conversion device 50. The heat dissipation member 7 includes the substrate 71 that supports the light source 41, and the plurality of fins 75 disposed at the substrate 71. The substrate 71 has the circulation port 713 that penetrates the substrate 71 and allows a part of the air current flowing through the heat dissipation member 7 to flow through the heat transfer member 65.

According to such a configuration, a part of the air current flowing through the heat dissipation member 7 passes through the circulation port 713 provided to the substrate 71 to flow through the heat transfer member 65, and the rest of the air current cools the heat dissipation member 7. Accordingly, the heat dissipation member 7 coupled to the light source 41 and the heat transfer member 65 coupled to the wavelength conversion device 50 can be cooled by the air current flowing from the fan 8 to the heat dissipation member 7, and by extension, the light source 41 and the wavelength conversion device 50 can be cooled. Therefore, since the number of fans can be reduced compared to when the fans are provided so as to correspond respectively to the light source 41 and the wavelength conversion device 50, it is possible to achieve a reduction in size of the light source device 4.

Further, since the air current having passed through the circulation port 713 flows through the heat transfer member 65, the temperature of the air current flowing through the heat transfer member 65 can be lowered compared to when the air current having cooled the entire heat dissipation member 7 flows through the heat transfer member 65. In other words, it is possible to make an air current having a relatively low temperature flow through the heat transfer member 65.

Therefore, it is possible to reduce the size of the light source device 4 while ensuring the cooling efficiency of the light source 41 and the wavelength conversion device 50.

In the light source device 4, the heat transfer member 65 includes the plurality of heat releasing pillars 656 disposed at the second surface 654 of the heat transfer member 65. The second surface 654 corresponds to an outer surface, and the heat releasing pillars 656 each correspond to a pillar.

According to such a configuration, since the contact area between the air current flowing through the heat transfer member 65 and the heat transfer member 65 can be increased, it is possible to make it easy to transfer the heat of the wavelength conversion device 50 transferred to the heat transfer member 65 to the air current flowing through the heat transfer member 65. Therefore, the cooling efficiency of the wavelength conversion device 50 can be improved.

In the light source device 4, the wavelength conversion device 50 includes the driver 505 that is a motor, the rotating plate 502 rotated by the driver 505, and the phosphor layer 503 that is disposed at the rotating plate 502 and converts the wavelength of the incident light. The heat transfer member 65 is coupled to the driver 505 in a heat-transferable manner.

According to such a configuration, since the heat transfer member 65 transfers the heat transferred from at least the driver 505 to the air current flowing through the heat transfer member 65, it is possible to increase the cooling efficiency of the driver 505, and by extension, it is possible to increase the cooling efficiency of the wavelength conversion device 50.

In the light source device 4, the housing chassis 61 has the first surface 611 at least a part of which is configured with the substrate 71, the second surface 612 crossing the first surface 611, and the third surface 613 crossing each of the first surface 611 and the second surface 612. At least a part of the third surface 613 is formed of the heat transfer member 65. The first surface 611 corresponds to the first outer surface, the second surface 612 corresponds to the second outer surface, and the third surface 613 corresponds to the third outer surface.

The air current having passed through the circulation port 713 flows along the second surface 612 and then flows along the heat transfer member 65.

According to such a configuration, the air current having passed through the circulation port 713 flows along the second surface 612 and then flows along the heat transfer member 65. Accordingly, as compared with when the air current having passed through the circulation port 713 directly flows to the heat transfer member 65, it is possible to make it easy to cause the air current to flow along the heat transfer member 65, and in addition, it is possible to make it easy to discharge the air current having flowed along the heat transfer member 65. Therefore, the cooling efficiency of the heat transfer member 65, and by extension, the cooling efficiency of the wavelength conversion device 50 can be increased.

In the light source device 4, the heat transfer member 65 has the first surface 651 that is located at the opposite side to the second surface 654 constituting the third surface 613 and receives the heat from the air current located in the housing space SP. The first surface 651 is a heat receiving surface.

According to such a configuration, since the heat in the housing space SP received by the first surface 651 is released to the outside of the housing chassis 61 by the second surface 654 of the heat transfer member 65, the temperature in the housing space SP can be lowered, and by extension, the cooling efficiency of the light source 41 and the wavelength conversion device 50 in the housing chassis 61 can be increased.

In the light source device 4, at least a part of the second surface 612 is configured with the lid member 63. The lid member 63 is a metal member that receives heat from the gas located in the housing space SP.

According to such a configuration, the air current having passed through the circulation port 713 cools the lid member 63 having received the heat from the gas located in the housing space SP, and then flows to the heat transfer member 65. Accordingly, since the temperature in the housing space SP can be lowered, the light source 41 and the wavelength conversion device 50 can be cooled inside the housing chassis 61. Therefore, the cooling efficiency of the light source 41 and the wavelength conversion device 50 can be increased.

The light source device 4 includes the duct 64 that guides the air current having passed through the circulation port 713 to the heat transfer member 65.

According to such a configuration, it is possible to make it easy to cause the air current having passed through the circulation port 713 to flow to the heat transfer member 65. Therefore, it is possible to increase the cooling efficiency of the heat transfer member 65, and by extension, the cooling efficiency of the wavelength conversion device 50 compared to when the air current having passed through the circulation port 713 flows to the heat transfer member 65 while diffusing.

Further, in the light source device 4, since it is possible to make it easy to cause the air current to flow through the lid member 63 with the duct 64, the cooling efficiency of the light source 41 and the wavelength conversion device 50 can be increased as described above.

The light source device 4 has the discharge port 66 configured with the duct 64 and the heat transfer member 65. The discharge port 66 is disposed in a portion downstream in the flow direction of the air current flowing through the heat transfer member 65, that is, a portion at the −Y direction side in the heat transfer member 65, and discharges the air current having flowed through the heat transfer member 65.

According to such a configuration, the air current having flowed through the heat transfer member 65 can quickly be discharged. Therefore, it is possible to increase the cooling efficiency of the heat transfer member 65, and by extension, the cooling efficiency of the wavelength conversion device 50 compared to when the air current having flowed through the heat transfer member 65 stagnates.

In the light source device 4, the circulation port 713 is configured with the plurality of openings 714 disposed at the substrate 71 at a distance from each other. The substrate 71 includes the coupling portion 715 that is disposed between the plurality of openings 714 and connects the respective inner edges of the plurality of openings 714.

According to such a configuration, the substrate 71 can be reinforced by the coupling portion 715. Further, the cable extending from the light source 41 can be disposed in the coupling portion 715.

In the light source device 4, the circulation port 713 and at least one of the plurality of fins 75 overlap each other when viewed along the flow direction of the air current with respect to the heat dissipation member 7. That is, as illustrated in FIG. 14, the circulation port 713 and at least one of the plurality of fins 75 overlap each other when viewed from the +X direction, and the same applies when viewed along the +X direction which is the flow direction of the air current.

According to such a configuration, it is possible to cause the air current that has cooled the at least one of the fins 75 to flow through the heat transfer member 65. Accordingly, it is possible to suppress a decrease in the cooling efficiency of the light source 41 compared to when a part of the air current flowing through the heat dissipation member 7 passes through the circulation port 713 without passing through the fins 75.

Note that, in general, since an upper limit of the allowable temperature range of the wavelength conversion device 50 is higher than an upper limit of the allowable temperature range of the light source 41, it is possible to make it easy to keep the temperatures of the light source 41 and the wavelength conversion device 50 within the allowable temperature ranges, respectively, even when the air current having flowed through the at least one of the fins 75 described above flows through the heat transfer member 65 to cool the wavelength conversion device 50.

In the light source device 4, the heat dissipation member 7 is disposed at the substrate 71 and has the vapor chamber 72 that receives heat from the light source 41. The plurality of fins 75 radiate the heat transferred from the vapor chamber 72.

According to such a configuration, since the vapor chamber 72 is high in thermal diffusion performance, it is possible to quickly transfer the heat of the light source 41 from the substrate 71 to each of the plurality of fins 75.

In the light source device 4, the heat dissipation member 7 includes the heat pipes 73 that transport the heat. The heat pipes 73 each have the heat receiving portion 731 coupled to the vapor chamber 72 and the heat releasing portion 732 that is coupled to at least one of the plurality of fins 75 and releases the heat received by the heat receiving portion 731 to that fin 75.

According to such a configuration, it is possible to make it easy for the heat pipe 73 to transfer the heat to the fin 75 to which the heat is hardly transferred from the vapor chamber 72 out of the plurality of fins 75. Accordingly, the heat can efficiently be transferred to the plurality of fins 75, and by extension, it is possible to make it easy for the plurality of fins 75 to transfer the heat to the air current flowing through the heat dissipation member 7. Therefore, the cooling efficiency of the light source 41 can be improved.

In the projector 1, the fan 8 is an axial fan. The circulation port 713 overlaps the fan 8 when viewing the heat dissipation member 7 from the fan 8 side, and is located closer to the circumferential edge of the fan 8 than to the center of the fan 8.

In general, in the flow rate distribution of the air current delivered by the axial fan, the closer to the center of the axial fan, the higher the flow rate, and the flow rate decreases toward the circumferential edge. Therefore, it is possible to ensure the cooling efficiency of the wavelength conversion device 50 by causing the air current at the circumferential edge side of the fan 8 to flow from the circulation port 713 to the heat transfer member 65 while ensuring the cooling efficiency of the light source 41 by delivering the air current delivered from a position close to the center of the axial fan to the plurality of fins 75.

### Modifications of Embodiment

The present disclosure is not limited to the embodiment described above, and modifications, improvements, and so on within a range in which the object of the present disclosure can be achieved should fall within the scope of the present disclosure.

In the embodiment described above, the air current having flowed through the circulation port 713 of the substrate 71 flows along the lid member 63, which is a metal member constituting the second surface 612, and then flows along the heat transfer member 65 constituting the third surface 613. However, this is not a limitation, and the air current having flowed through the circulation port 713 may directly flow to the heat transfer member 65. In this case, for example, a circulation port may be disposed along an end edge in the −Z direction of the substrate 71, and the air current having passed through the circulation port may be made to flow along the heat transfer member 65.

In the embodiment described above, the plurality of heat releasing pillars 656 are disposed at the second surface 654 which is the outer surface of the heat transfer member 65. However, this is not a limitation, and the heat transfer member 65 is not required to include the heat releasing pillars 656, and is not required to include the heat receiving pillars 653. Further, the heat transfer member 65 may include at least one fin instead of or in addition to the heat releasing pillars 656. Further, in the heat transfer member 65, the first surface 651 in contact with the gas located in the housing space SP is not required to be the heat receiving surface.

In the embodiment described above, the heat transfer member 65 is coupled to the driver 505 constituting the wavelength conversion device 50. However, this is not a limitation, and for example, when the wavelength conversion device 50 does not include the driver 505 and the phosphor layer 503 is not rotated, the heat transfer member 65 may be coupled to the phosphor layer 503 or a substrate that supports the phosphor layer 503.

In the embodiment described above, the lid member 63 that constitutes the housing chassis 61 together with the lower chassis 62 and is in contact with the gas located in the housing space SP is a metal member. However, this is not a limitation, and the lid member 63 may be made of a material other than metal, such as resin. Note that when the lid member 63 is made of metal, it is possible to improve the heat dissipation of the heat transferred from the gas located in the housing space SP.

In the embodiment described above, the duct 64 that causes the air current having passed through the circulation port 713 to flow to the lid member 63 and the heat transfer member 65 is provided. However, this is not a limitation, and the light source device 4 is not required to include the duct 64. In addition, the light source device 4 is not required to include the duct that causes the air current having passed through the circulation port 713 to flow to the lid member 63 and the heat transfer member 65. That is, the air current having flowed through the circulation port 713 may be caused to flow to the lid member 63 and the heat transfer member 65 using a configuration other than the light source device 4, such as the inner surface of the exterior chassis 2 or a member attached to the exterior chassis 2.

In the embodiment described above, the air current having flowed through the heat transfer member 65 is discharged to the outside of the light source device 4 through the discharge port 66 configured by combining the duct 64 and the heat transfer member 65 with each other. However, this is not a limitation, and the discharge port 66 may be configured only with the duct 64 or may be configured only with the heat transfer member 65.

In the embodiment described above, the circulation port 713 is configured with the plurality of openings 714 provided to the substrate 71 at a distance from each other, and the substrate 71 has the coupling portion 715 that connects the inner edges of the plurality of openings 714. However, this is not a limitation, and the circulation port 713 may be a single opening. Further, the number of openings 714 constituting the circulation port 713 is not limited to two, and the circulation port 713 may be configured with three or more openings 714.

In the embodiment described above, the heat dissipation member 7 includes the vapor chamber 72 provided to the substrate 71, and the plurality of fins 75 release the heat transferred from the vapor chamber 72. However, this is not a limitation, and the heat dissipation member 7 is not required to include the vapor chamber 72. For example, the heat of the light source 41 may be transferred to the plurality of fins 75 via the substrate 71. Further, for example, the heat pipe 73 may transfer, to the plurality of fins 75, the heat received from the substrate 71.

In the embodiment described above, the heat dissipation member 7 includes the heat pipes 73 that couple the vapor chamber 72 and the plurality of fins 75 to each other. However, this is not a limitation, and the heat pipes 73 may be eliminated. In this case, the heat releasing portion 723 of the vapor chamber 72 may be coupled to the plurality of fins 75.

In the embodiment described above, the fan 8 is an axial fan, and the circulation port 713 overlaps the fan 8 when the heat dissipation member 7 is viewed from the fan 8 side, and the circulation port 713 is located closer to the circumferential edge of the fan 8 than to the center of the fan 8. However, this is not a limitation, and the fan 8 may be a centrifugal fan such as a sirocco fan. Further, the positional relationship between the circulation port 713 and the fan 8 is not limited to the above, and for example, the circulation port 713 may be disposed at a position close to the center of the delivery range of the air current from the fan 8.

In the embodiment described above, the projector 1 includes the three light modulation devices 343R, 343G, and 343B. However, this is not a limitation, and the present disclosure is also applicable to a projector including two or fewer or four or more light modulation devices 343.

In the embodiment described above, the light modulation devices 343 are each configured with a transmissive liquid crystal panel in which a plane of incidence of light and a light exit surface are different from each other. However, this is not a limitation, and the light modulation devices 343 may each be configured with a reflective liquid crystal panel in which a plane of incidence of light and a light exit surface are the same. Further, a light modulation device other than liquid crystal such as a device using a micro mirror such as a digital micromirror device (DMD) may be applied to the projector 1 as long as the light modulation element is capable of modulating an incident light flux to form an image according to the image information.

In the embodiment described above, there is cited the example in which the light source device 4 is applied to the projector 1. However, this is not a limitation, and the light source device 4 may be used alone or may be applied to an illumination device. That is, the light source device according to the present disclosure may be adopted in an electronic apparatus other than the projector 1.

### SUMMARY OF PRESENT DISCLOSURE

A summary of the present disclosure will be appended below.

### Appendix 1

A light source device including:
a light source configured to emit light;
a heat dissipation member configured to dissipate heat of the light source;
a wavelength conversion device configured to convert a wavelength of the light emitted from the light source;
a housing chassis having a housing space in which the light source and the wavelength conversion device are housed; and
a heat transfer member that is provided to the housing chassis to constitute a part of an outer surface of the housing chassis, and is thermally coupled to the wavelength conversion device, wherein
the heat dissipation member includes a substrate to which the heat of the light source is transferred, and
a plurality of fins arranged at the substrate, and
the substrate has a circulation port that penetrates the substrate to allow a part of an air current flowing through the heat dissipation member to flow through the heat transfer member.

According to such a configuration, a part of the air current flowing through the heat dissipation member passes through the circulation port provided to the substrate to flow through the heat transfer member, and the rest of the air current cools the heat dissipation member. Accordingly, the heat dissipation member coupled to the light source and the heat transfer member coupled to the wavelength conversion device can be cooled by the air current flowing from, for example, a single fan to the heat dissipation member, and by extension, the light source and the wavelength conversion device can be cooled. Therefore, since the number of fans can be reduced compared to when the fans are provided so as to correspond respectively to the light source and the wavelength conversion device, it is possible to achieve a reduction in size of the light source device.

Further, since the air current having passed through the circulation port flows through the heat transfer member, the temperature of the air current flowing through the heat transfer member can be lowered compared to when the air current having cooled the entire heat dissipation member flows through the heat transfer member. In other words, it is possible to make an air current having a relatively low temperature flow through the heat transfer member.

Therefore, it is possible to reduce the size of the light source device while ensuring the cooling efficiency of the light source and the wavelength conversion device.

### Appendix 2

The light source device according to Appendix 1, wherein
the heat transfer member includes a plurality of pillars disposed at an outer surface of the heat transfer member.

According to such a configuration, since the contact area between the air current flowing through the heat transfer member and the heat transfer member can be increased, it is possible to make it easy to transfer the heat of the wavelength conversion device transferred to the heat transfer member to the air current flowing through the heat transfer member. Therefore, the cooling efficiency of the wavelength conversion device can be improved.

### Appendix 3

The light source device according to one of Appendices 1 and 2, wherein
the wavelength conversion device includes
a motor,
a rotating plate rotated by the motor, and
a phosphor layer provided to the rotating plate and configured to convert a wavelength of incident light, and
the heat transfer member is coupled to the motor in a heat-transferable manner.

According to such a configuration, since the heat transfer member transfers the heat transferred from at least the motor to the air current flowing through the heat transfer member, it is possible to increase the cooling efficiency of the motor, and by extension, it is possible to increase the cooling efficiency of the wavelength conversion device.

### Appendix 4

The light source device according to any one of Appendices 1 to 3, wherein
the housing chassis includes
a first outer surface at least a part of which is configured with the substrate,
a second outer surface crossing the first outer surface, and
a third outer surface which crosses each of the first outer surface and the second outer surface, and at least a part of which is configured with the heat transfer member, and
the air current that passed through the circulation port flows along the second outer surface and then flows along the heat transfer member.

According to such a configuration, the air current having passed through the circulation port flows along the second outer surface and then flows along the heat transfer member. Accordingly, as compared with when the air current having passed through the circulation port directly flows to the heat transfer member, it is possible to make it easy to cause the air current to flow along the heat transfer member, and in addition, it is possible to make it easy to discharge the air current having flowed along the heat transfer member. Therefore, the cooling efficiency of the heat transfer member, and by extension, the cooling efficiency of the wavelength conversion device can be increased.

### Appendix 5

The light source device according to Appendix 4, wherein
the heat transfer member has a heat receiving surface located at an opposite side to a surface constituting the third outer surface and configured to receive heat from a gas located in the housing space.

According to such a configuration, since the heat in the housing space received by the heat receiving surface is released to the outside of the housing chassis by the outer surface of the heat transfer member, the temperature in the housing space can be lowered, and by extension, the cooling efficiency of the light source and the wavelength conversion device in the housing chassis can be increased.

### Appendix 6

The light source device according to one of Appendices 4 and 5, wherein
at least a part of the second outer surface is formed of a metal member configured to receive heat from a gas located in the housing space.

According to such a configuration, the air current having passed through the circulation port cools the metal member that has received heat from the gas located in the housing space, and then flows through the heat transfer member. Accordingly, since the temperature in the housing space can be lowered, the light source and the wavelength conversion device can be cooled inside the housing chassis. Therefore, the cooling efficiency of the light source and the wavelength conversion device can be increased.

### Appendix 7

The light source device according to any one of Appendices 1 to 6, further including
a duct configured to guide the air current that passed through the circulation port to the heat transfer member.

According to such a configuration, it is possible to make it easy to cause the air current having passed through the circulation port to flow to the heat transfer member. Therefore, it is possible to increase the cooling efficiency of the heat transfer member, and by extension, the cooling efficiency of the wavelength conversion device compared to when the air current having passed through the circulation port flows to the heat transfer member while diffusing.

Note that in the configuration in which the air current having passed through the circulation port flows along the second outer surface and then flows through the heat transfer member, when at least a part of the second outer surface is formed of the metal member, the duct can make it easy to cause the air current to flow through the metal member. Therefore, the cooling efficiency of the light source and the wavelength conversion device can be increased.

### Appendix 8

The light source device according to appendix 7, further including
a discharge port that is configured with at least one of the duct and the heat transfer member, is disposed downstream in a flow direction of an air current flowing through the heat transfer member, and discharges the air current that flowed through the heat transfer member.

According to such a configuration, the air current having flowed through the heat transfer member can quickly be discharged. Therefore, it is possible to increase the cooling efficiency of the heat transfer member, and by extension, the cooling efficiency of the wavelength conversion device compared to when the air current having flowed through the heat transfer member stagnates.

### Appendix 9

The light source device according to any one of Appendices 1 to 8, wherein
the circulation port is formed of a plurality of openings provided to the substrate at a distance from each other, and
the substrate includes a coupling portion disposed between the plurality of openings to connect respective inner edges of the plurality of openings.

According to such a configuration, the substrate can be reinforced by the coupling portion disposed between the plurality of openings constituting the circulation port. Further, the cable extending from the light source can be disposed in the coupling portion.

### Appendix 10

The light source device according to any one of Appendices 1 to 9, wherein
the circulation port and at least one of the plurality of fins overlap each other when viewed along a flow direction of an air current with respect to the heat dissipation member.

According to such a configuration, since at least one of the plurality of fins to which the heat of the light source is transferred overlaps the circulation port when viewed along the flow direction of the air current with respect to the heat dissipation member, the air current that has cooled the at least one of the fins can be made to flow through the heat transfer member. Accordingly, it is possible to suppress a decrease in the cooling efficiency of the light source compared to when a part of the air current flowing through the heat dissipation member passes through the circulation port without passing through the fins.

Note that, in general, since an upper limit of the allowable temperature range of the wavelength conversion device is higher than an upper limit of the allowable temperature range of the light source, it is possible to make it easy to keep the temperatures of the light source and the wavelength conversion device within the allowable temperature ranges, respectively, even when the air current having flowed through the at least one of the fins described above flows through the heat transfer member to cool the wavelength conversion device.

### Appendix 11

The light source device according to any one of Appendices 1 to 10, wherein
the heat dissipation member includes a vapor chamber provided to the substrate and configured to receive heat from the light source, and
the plurality of fins dissipate heat transferred from the vapor chamber.

According to such a configuration, since the vapor chamber is high in thermal diffusion performance, it is possible to quickly transfer the heat of the light source from the substrate to each of the plurality of fins.

### Appendix 12

The light source device according to Appendix 11, wherein
the heat dissipation member includes a heat pipe configured to transport heat, and
the heat pipe includes
a heat receiving portion coupled to the vapor chamber and configured to receive heat, and
a heat releasing portion coupled to at least one of the plurality of fins and configured to release the heat received by the heat receiving portion to the at least one of the fins.

According to such a configuration, it is possible to make it easy for the heat pipe to transfer the heat to the fin to which the heat is hardly transferred from the vapor chamber out of the plurality of fins. Accordingly, the heat can efficiently be transferred to the plurality of fins, and by extension, it is possible to make it easy for the plurality of fins to transfer the heat to the air current flowing through the heat dissipation member. Therefore, the cooling efficiency of the light source can be improved.

### Appendix 13

A projector including:
the light source device according to any one of Appendices 1 to 12;
a light modulation device configured to modulate light emitted from the light source device;
a projection optical device configured to project the light modulated by the light modulation device; and
a fan configured to cause an air current to flow through the heat dissipation member.

According to such a configuration, it is possible to obtain substantially the same advantages as those of the light source device described above.

### Appendix 14

The projector according to appendix 13, wherein
the fan is an axial fan, and
the circulation port overlaps the fan when the heat dissipation member is viewed from the fan side, and is located closer to a circumferential edge of the fan than to a center of the fan.

In general, in the flow rate distribution of the air current delivered by the axial fan, the closer to the center of the axial fan, the higher the flow rate, and the flow rate decreases toward the circumferential edge. Therefore, it is possible to ensure the cooling efficiency of the wavelength conversion device by causing the air current at the circumferential edge side of the fan to flow from the circulation port to the heat transfer member while ensuring the cooling efficiency of the light source by delivering the air current delivered from a position close to the center of the axial fan to the plurality of fins.

What is claimed is:

1. A light source device including:
a light source configured to emit light;
a heat dissipation member configured to dissipate heat of the light source;
a wavelength conversion device configured to convert a wavelength of the light emitted from the light source;
a housing chassis having a housing space in which the light source and the wavelength conversion device are housed; and
a heat transfer member that is provided to the housing chassis to constitute a part of an outer surface of the housing chassis, and is thermally coupled to the wavelength conversion device, wherein
the heat dissipation member includes
a substrate to which the heat of the light source is transferred, and
a plurality of fins arranged at the substrate, and
the substrate has a circulation port that penetrates the substrate to allow a part of an air current flowing through the heat dissipation member to flow through the heat transfer member.

2. The light source device according to claim 1, wherein
the heat transfer member includes a plurality of pillars disposed at an outer surface of the heat transfer member.

3. The light source device according to claim 1, wherein
the wavelength conversion device includes
a motor,
a rotating plate rotated by the motor, and
a phosphor layer provided to the rotating plate and configured to convert a wavelength of incident light, and
the heat transfer member is coupled to the motor in a heat-transferable manner.

4. The light source device according to claim 1, wherein
the housing chassis includes
a first outer surface at least a part of which is configured with the substrate,
a second outer surface crossing the first outer surface, and
a third outer surface which crosses each of the first outer surface and the second outer surface, and at least a part of which is configured with the heat transfer member, and
the air current that passed through the circulation port flows along the second outer surface and then flows along the heat transfer member.

5. The light source device according to claim 4, wherein
the heat transfer member has a heat receiving surface located at an opposite side to a surface constituting the third outer surface and configured to receive heat from a gas located in the housing space.

6. The light source device according to claim 4, wherein
at least a part of the second outer surface is formed of a metal member configured to receive heat from a gas located in the housing space.

7. The light source device according to claim 1, further comprising
a duct configured to guide the air current that passed through the circulation port to the heat transfer member.

8. The light source device according to claim 7, further comprising
a discharge port that is configured with at least one of the duct and the heat transfer member, is disposed downstream in a flow direction of an air current flowing through the heat transfer member, and discharges the air current that flowed through the heat transfer member.

9. The light source device according to claim 1, wherein
the circulation port is formed of a plurality of openings provided to the substrate at a distance from each other, and
the substrate includes a coupling portion disposed between the plurality of openings to connect respective inner edges of the plurality of openings.

10. The light source device according to claim 1, wherein
the circulation port and at least one of the plurality of fins overlap each other when viewed along a flow direction of an air current with respect to the heat dissipation member.

11. The light source device according to claim 1, wherein
the heat dissipation member includes a vapor chamber provided to the substrate and configured to receive heat from the light source, and
the plurality of fins dissipate heat transferred from the vapor chamber.

12. The light source device according to claim 11, wherein
the heat dissipation member includes a heat pipe configured to transport heat, and
the heat pipe includes
a heat receiving portion coupled to the vapor chamber and configured to receive heat, and
a heat releasing portion coupled to at least one of the plurality of fins and configured to release the heat received by the heat receiving portion to the at least one of the fins.

13. A projector including:
the light source device according to claim 1;
a light modulation device configured to modulate light emitted from the light source device;
a projection optical device configured to project the light modulated by the light modulation device; and
a fan configured to cause an air current to flow through the heat dissipation member.

14. The projector according to claim 13, wherein
the fan is an axial fan, and
the circulation port overlaps the fan when the heat dissipation member is viewed from the fan side, and is located closer to a circumferential edge of the fan than to a center of the fan.
